(19) United States
(12) Patent Application Publication
(10) Pub. No.: US 2021/0403662 A1
(43) Pub. Date: Dec. 30, 2021

(54) METHODS OF REPLENISHING A WRITABLE AND CLEANABLE ARTICLE AND KITS

(71) Applicant: 3M INNOVATIVE PROPERTIES COMPANY, St. Paul, MN (US)

(72) Inventors: Zachary J. Malmberg, Roseville, MN (US); Justin A. Riddle, St. Paul, MN (US); Syud M. Ahmed, Minneapolis, MN (US); Derek A. Huntley, Lake Elmo, MN (US); Lynn E. Lorimor, Minneapolis, MN (US); Robert S. Mulder, Blaine, MN (US)

(21) Appl. No.: 16/981,922

(22) PCT Filed: Mar. 18, 2019
(86) PCT No.: PCT/IB2019/052190

§ 371 Date: Sep. 17, 2020

Related U.S. Application Data
(60) Provisional application No. 62/645,129, filed on Mar. 19, 2018.

(51) Int. Cl. C08J 7/056; B05D 7/00; B05D 3/02; C08J 7/043

(52) U.S. Cl. CPC C08J 7/056; B05D 7/58; C08J 2300/00; C08J 7/043; B05D 3/0254

(57) ABSTRACT

Methods and kits including writable and cleanable articles, wherein in one embodiment, a method of replenishing a hydrophilic surface on a writable and cleanable article is provided. The method comprising: providing a writable and cleanable article that includes a hydrophilic overcoat that has an at least partially depleted (i.e., at least partially exhausted) hydrophilic surface; and applying a cleaning and protecting composition to at least a portion of the hydrophilic overcoat; and drying the cleaning and protecting composition to provide a dried surface having a replenished hydrophilic surface. The writable and cleanable article includes: a base member having a front surface; a facing layer comprising a cured polymeric matrix and a plurality of inorganic nanoparticles dispersed in the polymeric matrix, wherein the facing layer is disposed on at least a portion of the base member front surface; an optional primer layer disposed on at least a portion of the facing layer; and a hydrophilic overcoat bonded to the facing layer and/or the optional primer layer through siloxane bonds, thereby providing a hydrophilic surface that is writable and cleanable. The cleaning and protecting composition includes: a hydrophilic silane; a surfactant; and water.

### BACKGROUND

Easy cleanability of surfaces, e.g., removal of dirt and grime, graffiti, or erasable surfaces, is a long standing desired feature. Illustrative applications where easy cleanability is desired include windows, electronic device screens, work surfaces, appliances, door and wall surfaces, signs, vehicle surfaces such as on trains or buses, etc. Other illustrative applications include writable surfaces such as dry erase boards, file folders, notebooks, etc., where effective writability coupled with later easy removal of the writing is desired.

Articles having cleanable surfaces have been made from a variety of materials offering various combinations of properties. Commonly recognized embodiments include certain label materials, dry erase articles, note papers, file folders with cleanable tabs, etc.

Dry erase boards have been used as writing surfaces for years because of their convenience and versatility. The boards provide a means for expression which eliminates the mess and trouble of a chalk board.

A standing challenge for dry erase articles is to find surfaces that can be easily cleaned, resist staining when written on with permanent markers, can be easily erased when written on with conventional dry erase markers, are durable, and so forth. Glass and porcelain surfaces have been long used in the writing surfaces of dry erase articles, but improved performance is desired. For instance, though their non-porous surfaces are easily written on with dry erase markers and then easily erased after one day, the writing builds adhesion to the board over time becoming difficult or even impossible to remove by wiping with a dry eraser. Dry erase writing that is not removable by a dry eraser is commonly called ghosting. In addition, permanent markers tend to adhere well to such surfaces and cannot be easily removed. For example, such writing is often removable only with solvents such as isopropanol. Solvent-based cleaners are being replaced in the marketplace with cleaners containing water, surfactant, and a few percent of a less volatile organic solvent. Such cleaners are not always capable of removing permanent marker writing from dry erase boards, however. Other common dry erase surfaces with the same cleaning problems include coated film, melamine, and painted plastic and steel.

A continuing need exists for methods of cleaning, protecting, and restoring writable and cleanable surfaces.

### SUMMARY

Writable and cleanable articles described herein can be easily and effectively cleaned repeatedly. Accordingly, such articles can be used in many demanding applications, for instance, they are particularly well suited for use as dry erase surfaces. They exhibit excellent writability with conventional dry erase markers, yet writing from permanent markers can be readily removed therefrom with water and a cloth or eraser. No special solvents or tools need be used. With time, however, even such advantageous properties can be exhausted due to depletion of the surface layer(s) that make them writable and cleanable. The compositions used in the methods described herein can improve performance, particularly with respect to cleanability, of a writable and cleanable article. The compositions used in the methods described herein can also replenish performance, particularly with respect to cleanability, and in certain embodiments, with respect to writability, to that of (or close to that of) an original, unused writable and cleanable article.

In one embodiment, a method of replenishing a hydrophilic surface on a writable and cleanable article is provided. The method comprising: providing a writable and cleanable article that includes a hydrophilic overcoat that has an at least partially depleted (i.e., at least partially exhausted) hydrophilic surface; and applying a cleaning and protecting composition to at least a portion of the hydrophilic overcoat; and drying the cleaning and protecting composition to provide a dried surface having a replenished hydrophilic surface. The writable and cleanable article includes: a base member having a front surface; a facing layer comprising a cured polymeric matrix and a plurality of inorganic nanoparticles dispersed in the polymeric matrix, wherein the facing layer is disposed on at least a portion of the base member front surface; an optional primer layer disposed on at least a portion of the facing layer; and a hydrophilic overcoat bonded to the facing layer and/or the optional primer layer through siloxane bonds, thereby providing a hydrophilic surface that is writable and cleanable. The cleaning and protecting composition includes a hydrophilic silane, a surfactant, and water, and can replenish performance, particularly with respect to cleanability, and in certain embodiments, with respect to writability, to that of (or close to that of) an original, unused writable and cleanable article.

In one embodiment, a method of cleaning and protecting a writable and cleanable article is provided. The method includes: providing a writable and cleanable article applying a cleaning and protecting composition to at least a portion of the writable and cleanable hydrophilic surface; and drying the cleaning and protecting composition to provide a dried surface. The writable and cleanable article includes: a base member having a front surface; a facing layer comprising a cured polymeric matrix and a plurality of inorganic nanoparticles dispersed in the polymeric matrix, wherein the facing layer is disposed on at least a portion of the base member front surface; an optional primer layer disposed on at least a portion of the facing layer; and a hydrophilic overcoat bonded to the facing layer and/or the optional primer layer through siloxane bonds, thereby providing a hydrophilic surface that is writable and cleanable. The cleaning and protecting composition includes a hydrophilic silane, a surfactant, and water, and can improve performance, particularly with respect to cleanability, of the writable and cleanable article.

In one embodiment, a kit is provided that includes: a writable and cleanable article; and a cleaning and protecting composition. The writable and cleanable article includes: a base member having a front surface; a facing layer comprising a cured polymeric matrix and a plurality of inorganic nanoparticles dispersed in the polymeric matrix, wherein the facing layer is disposed on at least a portion of the base member front surface; an optional primer layer disposed on at least a portion of the facing layer; and a hydrophilic overcoat bonded to the facing layer and/or the optional primer layer through siloxane bonds, thereby providing a hydrophilic surface that is writable and cleanable. The cleaning and protecting composition includes a hydrophilic silane, a surfactant, and water, and can be provided impregnated in an absorbent substrate. Any embodiment of a writable and cleanable article as described herein can be used in combination with any embodiment of a cleaning and protecting composition as described herein.

The term “surfactant” means molecules that include hydrophilic (i.e., polar) and hydrophobic (i.e., non-polar) regions on the same molecule.

The term “aqueous” means water is present.

The term “water soluble” means a compound, composition, or material that forms a solution in water.

The term “solution” means a homogeneous composition in which the solute is dissolved in the solvent and cannot be separated from the solvent by filtration or physical means.

As used herein, the following terms have the indicated meanings: “organic group” means a hydrocarbon group (with optional elements other than carbon and hydrogen, such as oxygen, nitrogen, sulfur, and silicon) that is classified as an aliphatic group, cyclic group, or combination of aliphatic and cyclic groups (e.g., alkaryl and aralkyl groups), in the context of the present disclosure, the organic groups are those that do not interfere with the formation of a wipe-away dry erase and permanent marker surface; “aliphatic group” means a saturated or unsaturated linear or branched hydrocarbon group, this term is used to encompass alkyl, alkenyl, and alkynyl groups, for example; “alkyl group” means a saturated linear or branched hydrocarbon group including, for example, methyl, ethyl, isopropyl, t-butyl, heptyl, dodecyl, octadecyl, amyl, 2-ethylhexyl, and the like; “alkylene group” is a divalent alkyl group; “alkenyl group” means an unsaturated, linear or branched hydrocarbon group with one or more carbon-carbon double bonds, such as a vinyl group; “alkynyl group” means an unsaturated, linear or branched hydrocarbon group with one or more carbon-carbon triple bonds; “cyclic group” means a closed ring hydrocarbon group that is classified as an alicyclic group, aromatic group, or heterocyclic group; “alicyclic group” means a cyclic hydrocarbon group having properties resembling those of aliphatic groups; “aromatic group” or “aryl group” means a mono- or polynuclear aromatic hydrocarbon group; and “heterocyclic group” means a closed ring hydrocarbon in which one or more of the atoms in the ring is an element other than carbon (e.g., nitrogen, oxygen, sulfur, etc.). A group that may be the same or different is referred to as being “independently” something.

Substitution is anticipated on the organic groups of the complexes of the present disclosure. As a means of simplifying the discussion and recitation of certain terminology used throughout this application, the terms “group” and “moiety” are used to differentiate between chemical species that allow for substitution or that may be substituted and those that do not allow or may not be so substituted. Thus, when the term “group” is used to describe a chemical substituent, the described chemical material includes the unsubstituted group and that group with O, N, Si, or S atoms, for example, in the chain (as in an alkoxy group) as well as carbonyl groups or other conventional substitution. Where the term “moiety” is used to describe a chemical compound or substituent, only an unsubstituted chemical material is intended to be included. For example, the phrase “alkyl group” is intended to include not only pure open chain saturated hydrocarbon alkyl substituents, such as methyl, ethyl, propyl, t-butyl, and the like, but also alkyl substituents bearing further substituents known in the art, such as hydroxy, alkoxy, alkylsulfonyl, halogen atoms, cyano, nitro, amino, carboxyl, etc. Thus, “alkyl group” includes ether groups, haloalkyls, nitroalkyls, carboxyalkyls, hydroxyalkyls, sulfoalkyls, etc. On the other hand, the phrase “alkyl moiety” is limited to the inclusion of only pure open chain saturated hydrocarbon alkyl substituents, such as methyl, ethyl, propyl, t-butyl, and the like.

Herein, the term “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof).

The words “preferred” and “preferably” refer to embodiments of the disclosure that may afford certain benefits, under certain circumstances. However, other claims may also be preferred, under the same or other circumstances. Furthermore, the recitation of one or more preferred claims does not imply that other claims are not useful, and is not intended to exclude other claims from the scope of the disclosure.

In this application, terms such as “a,” “an,” and “the” are not intended to refer to only a singular entity, but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

Also herein, all numbers are assumed to be modified by the term “about” and in certain embodiments, preferably, by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

As used herein, the terms “ambient temperature” or “room temperature” refers to a temperature of 20° C. to 25° C. or 22° C. to 25° C.

The term “in the range” or “within a range” (and similar statements) includes the endpoints of the stated range.

Groupings of alternative elements or embodiments disclosed herein are not to be construed as limitations. Each group member may be referred to and claimed individually or in any combination with other members of the group or other elements found therein. It is anticipated that one or more members of a group may be included in, or deleted from, a group for reasons of convenience and/or patentability. When any such inclusion or deletion occurs, the specification is herein deemed to contain the group as modified thus fulfilling the written description of all Markush groups used in the appended claims.

When a group is present more than once in a formula described herein, each group is “independently” selected, whether specifically stated or not. For example, when more than one R group is present in a formula, each R group is independently selected.

Reference throughout this specification to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more embodiments.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list. Thus, the scope of the present disclosure should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Although various theories and possible mechanisms may have been discussed herein, in no event should such discussions serve to limit the claimable subject matter.

### BRIEF DESCRIPTION OF THE DRAWING

FIG. 1 is a schematic view of an illustrative embodiment of a cleanable article of the disclosure. This FIGURE is not to scale and are intended to be merely illustrative and not limiting.

### DETAILED DESCRIPTION OF ILLUSTRATIVE EMBODIMENTS

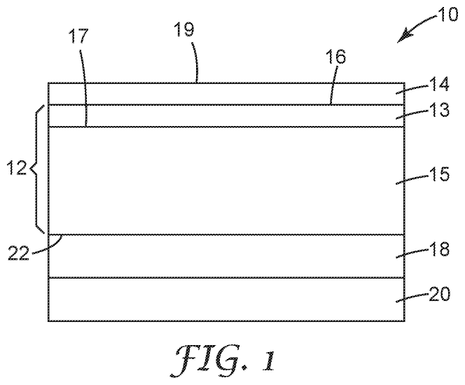

FIG. 1 shows an illustrative embodiment of a writable and cleanable article 10 comprising body member 12 with overcoat 14 siloxane bonded to the front surface 16 thereof. The surface 19 of the overcoat is a hydrophilic cleanable and writable surface. In the embodiment shown, body member 12 comprises base member 15 with facing layer 13 on the front surface 17 thereof. Article 10 further comprises optional adhesive layer 18 and optional removable liner 20 on the back surface 22 of body member 12. That is, an adhesive layer 18 may be disposed on the back surface 22 of the base member 15, and a removable liner 20 disposed on the adhesive layer 18.

In certain embodiments, the writable and cleanable article 10 includes: a base member 12 having a front surface 17; a facing layer 13 that includes a cured polymeric matrix (organic or inorganic polymeric matrix) and a plurality of inorganic nanoparticles dispersed in the cured polymeric matrix, wherein the facing layer is disposed on at least a portion of the base member front surface; an optional primer layer (not shown) disposed on at least a portion of the facing layer 13; and a hydrophilic overcoat 14 bonded to the facing layer 13 and/or the optional primer layer through siloxane bonds; wherein the hydrophilic overcoat provides a writable and cleanable surface.

Generally, such writable and cleanable articles can be easily and effectively cleaned repeatedly. With time, however, the hydrophilic overcoat 14 may wear away, exposing the underlying optional primer layer and/or the facing layer 13. Thus, the advantageous properties of writing, cleaning, rewriting, cleaning, etc. can be exhausted due to at least partial depletion of the hydrophilic surface that makes such articles writable and cleanable. The compositions used in the methods described herein can improve performance, particularly with respect to cleanability, of a writable and cleanable article. The compositions used in the methods described herein can also replenish performance, particularly with respect to cleanability, and in certain embodiments, with respect to writability, to that of (or close to that of) an original, unused writable and cleanable article.

Illustrative examples of writable and cleanable articles include individual or padded sheets (e.g., similar to paper), films, adhesive-back labels, incorporated into folders, notebook covers, dry erase articles, etc. For example, in some embodiments, the article is a film with a cured coating (i.e., facing layer) on a portion of one side and an adhesive on a portion of the other side of the film, wherein film is laminated to a second substrate which is then framed to make a dry erase board.

In addition, writable and cleanable articles of the disclosure, e.g., dry erase articles, can further comprise such other optional components as frames, means for storing materials and tools such as writing instruments, erasers, cloths, note paper, etc., handles for carrying, protective covers, means for hanging on vertical surfaces, easels, etc.

### Body Member of Article

The body member typically substantially constitutes the main portion of the article for which a writable and cleanable surface in accordance with the disclosure is desired. For instance, it may be a panel of a door, window, ceiling, or other architectural surface, a surface of a cabinet or piece of furniture, surface of a sign or white board, a surface on a personal article such as a notebook, clipboard, etc. The body member may be a film capable of being adhered to another surface (e.g., a door, window, ceiling, or other architectural surface, or a vehicle).

In addition to exhibiting other desired characteristics, the front surface 16 of the body member 12 exhibits siloxane-bondable character. Typically, siloxane-bondable capability of the body member 12 is achieved by incorporating a siloxane-bondable layer 13 (i.e., a facing layer) as the front surface 16 of the body member 12, e.g., by forming a suitable layer (e.g., facing layer with optional primer) on an underlying base member 15. In this context, “siloxane-bondable” means that the surface has functional groups (e.g., —OH groups) capable of forming siloxane bonds.

### Base Member of Body Member

Typically, the base member 15 has a surface comprising a sheet of glass, ceramic, porcelain, paper, metal, organic polymer, or combinations thereof. In certain embodiments, base member 15 may comprise, consist essentially of, or consist of, any of a variety of organic polymeric materials or non-organic or non-polymeric materials. Examples of suitable materials include glass, metal sheeting, paper, cardboard, knitted materials, fabrics, or the like.

The base member 15 may be composed of a single layer or multiple layers (e.g., coextruded multilayer films).

As desired, the base member may be opaque, translucent, transparent, or clear. In some embodiments, the base member will be retroreflective. The term transparent means transmitting at least 85% of incident light in the visible spectrum (400 nanomaters (nm) to 700 nm wavelength). Base members (i.e., substrates) may be colored.

The base member 15 may be flexible or inflexible.

In some embodiments, the base member will be substantially self-supporting, i.e., sufficiently dimensionally stable to hold its shape as it is moved, used, and otherwise manipulated. In some embodiments, the article will be further supported in some fashion, e.g., with a reinforcing frame, adhered to a supporting surface, etc.

If desired, the body member may be provided with graphics on the surface thereof or embedded therein, such as words or symbols as known in the art, which will be visible through the overlying overcoat. For example, decorative or organizational graphics, headings, etc., may be provided in the article so as to be visible to viewers, e.g., by the application of legends, decorative emblems, information headings, on the front surface 17 of the base member 15. Also, the base member may be opaque and/or colored to impart desired appearance to the resultant article (e.g., a dry erase article).

In many embodiments the base member will be substantially planar but as will be understood may also be configured in curved or complex shapes.

Any of a variety of materials may be suitable for use as base member 15 including flexible materials such as, for example, woven materials, knitted materials, films (e.g., polymeric films), nonwovens, metal sheet, metal foil, glass film, and the like. In some embodiments, the flexible material includes a woven material, a nonwoven material, a knitted material, a film (e.g., a polymeric film), and the like.

In some embodiments, the base member is a polymeric film. Illustrative examples include polymeric films selected from the group consisting of a polyester (e.g., polyethylene terephthalate and polybutyleneterephthalate), olefin (e.g., polyethylene, polypropylene, and copolymers of propylene, ethylene, and butene), polyamide, polyimide, phenolic resin, polyvinyl chloride, polycarbonate, allyldiglycolcarbonate, polyacrylate (e.g., polymethyl methacrylate), polystyrene, styrene-acrylonitrile copolymer, polysulfone, polyethersulfone, cellulose ester (e.g., acetate and butyrate), biopolymer, polylactic acid, homo-epoxy polymer, epoxy addition polymer with a polydiamine or polydithiol, and a combination of any of the foregoing (e.g., copolymers, mixtures, or blends) thereof.

In some embodiments where the article 10 is a film product intended for use in optical applications such as in an optical display, the substrate material will be chosen based in part on the desired optical and mechanical properties for the intended use. Mechanical properties can include flexibility, dimensional stability, and impact resistance.

In some embodiments, an optically clear material may be desired. The term “optically clear” refers to the transparency of a material, typically permitting a high level (e.g., more than 99% when corrected for reflection losses) of light transmission and low haze (e.g., less than 1%). Examples of suitable optically clear materials include optically clear polyester film, triacetate (TAC) film, polyethylene naphthalate, polycarbonate, cellulose acetate, poly(methyl methacrylate), polyolefins such as biaxially oriented polypropylene (BOPP) and simultaneously biaxially-oriented polypropylene (S-BOPP).

The thickness of the base member can vary and will typically depend on the intended use of the final article. In some embodiments, base member thicknesses are less than 0.5 mm and typically no more than 0.2 mm. In some embodiments, a base member thickness is at least 0.02 mm.

Polymeric materials can be formed using conventional film-making techniques (e.g., extrusion and optional uniaxial or biaxial orientation of the extruded film).

In certain embodiments, the base member 15 can be treated to improve adhesion with the facing layer 13. Exemplary of such treatment includes chemical treatment, corona treatment (e.g., air or nitrogen corona), plasma treatment, flame treatment, or actinic radiation treatment. Interlayer adhesion can also be improved with the use of an optional tie layer. A combination of treatments and/or tie layers may be used if desired. Thus, the facing layer 13 may be disposed directly on the front surface 15 of the base member 15 or through a tie layer.

Where the finished articles are intended to be used in display panels, the base member 15 and other components of article 10 are typically light transmissive, meaning light can be transmitted so that the display can be viewed. Suitable light transmissive optical films include, without limitation, multilayer optical films, microstructured films such as retroreflective sheeting and brightness enhancing films (e.g., reflective or absorbing), polarizing films, diffusive films, as well as retarder films and compensator films, such as described in U.S. Pat. No. 7,099,083 (Johnson et al.).

The finished articles may be used in multilayer optical films, such as described in, e.g., U.S. Pat. No. 6,991,695 (Tait et al.). Exemplary materials that can be used in the fabrication of polymeric multilayer optical films can be found in PCT Publication No. WO 99/36248 (Neavin et al.). Further details of suitable multilayer optical films and related constructions can be found in U.S. Pat. No. 5,882,774 (Jonza et al.), and PCT Publication Nos. WO 95/17303 (Ouderkirk et al.) and WO 99/39224 (Ouderkirk et al.). Polymeric multilayer optical films can include additional layers and coatings selected for their optical, mechanical, and/or chemical properties. The polymeric films can also include inorganic layers, such as metal or metal oxide coatings or layers. Other base members for use in the body members of article 10 of the present disclosure are disclosed in U.S. Pat. No. 9,527,336 (Mahli et al.).

### Front Surface of Body Member (Facing Layer)

At least a portion of the front surface 16 of the body member 12 (i.e., front surface 16 of the facing layer 13), and preferably essentially the entire front surface thereof, is siloxane-bondable, i.e., capable of forming siloxane bonds with a compatibly formulated overcoat 14. This characteristic is typically provided herein by exposed siloxane-bondable particles entrained in a cured polymeric matrix in the facing layer 13 and/or by an optional siloxane-bondable primer layer such as diamond-like glass (described further below).

Depending upon the desired application, the front surface 16 of the body member 12 may have a matte finish or a glossy finish. The term “matte finish” means a rough or granular surface finish or texture that is lacking a high luster or gloss. The matte finish may be smooth to the touch but is generally free from significant shine or highlights.

Typically, although not required, the front surface 16 of the facing layer 13 is also a writable surface (i.e., writing surface), which is a surface on which can be written with a dry-erase marker, for example.

In certain embodiments, the facing layer is no greater than 10 microns thick, and often no greater than 1 micron thick. In certain embodiments, the facing layer is at least 100 nanometers (nm) thick.

In a typical embodiment, the facing layer 13 is a non-tacky, crosslinked polymeric coating or layer formed from a curable coating composition. The non-tacky, crosslinked polymeric coating or layer includes an organic polymeric matrix (e.g., a (meth)acrylate polymeric matrix) or an inorganic polymeric matrix (e.g., a siloxane polymeric matrix).

A curable coating composition typically includes organic monomers, oligomers, and/or polymerizable polymers, which may be monofunctional and/or polyfunctional. Polymerizable organic materials may be, for example, free-radically polymerizable, cationically polymerizable, and/or condensation polymerizable. In some embodiments, a curable coating composition also includes a curative.

Curable coating compositions (i.e., coatable materials or coatable compositions that are non-solid (e.g., liquid or gel-like) and capable of being coated onto a surface) suitable for use herein may include any of a variety of film forming materials. In some embodiments, the coatable material is a polymeric material comprised of one or more polymers and/or oligomers in solvent. In some embodiments, the coatable material is a mixture of one or more monomers, oligomers, and/or polymers in one or more solvents.

Useful polymerizable materials (i.e., one or more monomers, oligomers, and/or polymerizable polymers) include, for example, (meth)acrylates (i.e., acrylates and methacrylates), epoxies, isocyanates, vinyl chlorides, vinyl acetates, isoprene, butadiene, styrene, trialkoxysilane-terminated oligomers and polymers, and combinations thereof.

In certain embodiments, the polymerizable material comprises a free-radically polymerizable material. Useful free-radically polymerizable materials include, for example, free-radically polymerizable monomers and/or oligomers, either or both of which may be monofunctional or multifunctional. Exemplary free-radically polymerizable monomers include styrene and substituted styrenes (e.g., alpha-methylstyrene); vinyl esters (e.g., vinyl acetate); vinyl ethers (e.g., butyl vinyl ether); N-vinyl compounds (e.g., N-vinyl-2-pyrrolidone, N-vinylcaprolactam); acrylamide and substituted acrylamides (e.g., N,N-dialkylacrylamides); and acrylates and/or methacrylates (i.e., collectively referred to herein as (meth)acrylates) (e.g., isooctyl (meth)acrylate, nonylphenol ethoxylate (meth)acrylate, isononyl (meth)acrylate, diethylene glycol (meth)acrylate, isobornyl (meth)acrylate, 2-(2-ethoxyethoxy)ethyl (meth)acrylate, 2-ethylhexyl (meth)acrylate, lauryl (meth)acrylate, butanediol mono(meth)acrylate, β-carboxyethyl (meth)acrylate, isobutyl (meth)acrylate, 2-hydroxyethyl (meth)acrylate, (meth)acrylonitrile, isodecyl (meth)acrylate, dodecyl (meth)acrylate, n-butyl (meth)acrylate, methyl (meth)acrylate, hexyl (meth)acrylate, (meth)acrylic acid, stearyl (meth)acrylate, hydroxy functional polycaprolactone ester (meth)acrylate, hydroxyethyl (meth)acrylate, hydroxymethyl (meth)acrylate, hydroxypropyl (meth)acrylate, hydroxyisopropyl (meth)acrylate, hydroxybutyl (meth)acrylate, hydroxyisobutyl (meth)acrylate, tetrahydrofurfuryl (meth)acrylate, ethylene glycol di(meth)acrylate, hexanediol di(meth)acrylate, triethylene glycol di(meth)acrylate, 1,3-propylene glycol di(meth)acrylate, tetraethylene glycol di(meth)acrylate, trimethylolpropane tri(meth)acrylate, 1,4-cyclohexanediol di(meth)acrylate, 1,5-pentanediol di(meth)acrylate, ethoxylated trimethylolpropane tri(meth)acrylate, glycerol tri(meth)acrylate, pentaerythritol tri(meth)acrylate, pentaerythritol tetra(meth)acrylate, dipentaerythritol penta(meth)acrylate, and neopentyl glycol di(meth)acrylate).

Exemplary free-radically polymerizable oligomers include those marketed by UCB Chemicals, Smyrna, Ga. (e.g., under the trade designation EBECRYL), and those marketed by Sartomer Company, Exton, Pa. (e.g., under the trade designations KAYARAD or CN).

In some illustrative embodiments, the facing layer comprises a layer of the reaction product of a mixture comprising at least one curable component selected from the group consisting of (meth)acrylate monomers, (meth)acrylate oligomers, and combinations thereof. Other curable materials will be selected for still other embodiments in accordance with the present disclosure.

Depending on the choice of polymerizable material, the curable coating composition may, optionally, contain one or more curatives that assist in polymerizing the polymerizable material. The choice of curative for specific polymerizable materials depends on the chemical nature of the copolymerizable material. For example, in the case of epoxy resins, one would typically select a curative known for use with epoxy resins (e.g., dicyandiamide, onium salt, or polymercaptan). In the case of free-radically polymerizable resins, free radical thermal initiators and/or photoinitiators are useful curatives.

Typically, the optional curative(s) is used in an amount effective to facilitate polymerization of the polymerizable material and the amount will vary depending upon, for example, the type of curative, the molecular weight of the curative, and the polymerization process. The optional curative(s) is typically included in the curable coating composition in an amount in a range of from 0.01 percent by weight (wt-%) to 10 wt-%, based on the total weight of the curable coating composition, although higher and lower amounts may also be used. If the optional curative is a free-radical initiator, the amount of curative is preferably in a range of from 1 wt-% to 5 wt-%, based on the total weight of the curable coating composition, although higher and lower amounts may also be used.

Exemplary free-radical photoinitiators include, for example, benzoin ethers such as benzoin methyl ether and benzoin isopropyl ether, substituted benzoin ethers (e.g., anisoin methyl ether), substituted acetophenones (e.g., 2,2-dimethoxy-2-phenylacetophenone), substituted alpha-ketols (e.g., 2-methyl-2-hydroxypropiophenone), benzophenone derivatives (e.g., benzophenone), and acylphosphine oxides. Exemplary commercially available photoinitiators include photoinitiators under the trade designation IRGACURE (e.g., IRGACURE 651, IRGACURE 184, and IRGACURE 819) or DAROCUR (e.g., DAROCUR 1173, DAROCUR 4265) from Ciba Specialty Chemicals, Tarrytown, N.Y., and under the trade designation LUCIRIN (e.g., LUCIRIN TPO) from BASF, Parsippany, N.J. Exemplary free-radical thermal initiators include peroxides such as benzoyl peroxide, dibenzoyl peroxide, dilauryl peroxide, cyclohexane peroxide, methyl ethyl ketone peroxide, hydroperoxides, for example, tert-butyl hydroperoxide and cumene hydroperoxide, dicylohexyl peroxydicarbonate, t-butyl perbenzoate, and azo compounds, for example, 2, 2,-azo-bis(isobutyronitrile).

A curable coating composition may be cured, for example, by exposure to a thermal source (e.g., heat, infrared radiation), electromagnetic radiation (e.g., ultraviolet and/or visible radiation), and/or particulate radiation (e.g., electron beam of gamma radiation).

A curable coating composition from which the facing layer is formed is preferably fully cured. In particular, at least that portion of the composition that forms a writing surface should be fully cured. A variety of curing strategies are well known to those skilled in the art and suitable one(s) can be readily selected, determined in part upon the characteristics of the curable coating composition, other components of the article, as well as manufacturing facilities. Illustrative techniques for maximizing the cure of a UV-cured coating composition include curing under nitrogen, using new UV bulbs, cleaning the UV bulbs before use, matching the output spectrum of the UV bulb to the absorption of the initiator, and treatment at a slow speed and/or for a longer time. In some embodiments, a certain amount of post-exposure cure may take place over time as the article ages at room temperature. In certain embodiments, a second cure treatment may be required in addition to the first cure described above. The second cure may use the same radiation source as the first cure or it may use a different radiation source. Preferred second cure methods include heat, electron beam, and gamma ray treatment.

The facing layer further includes a plurality of inorganic nanoparticles dispersed in the cured polymeric matrix. Such nanoparticles provide a facing layer with exposed —OH groups prior to bonding to the hydrophilic overcoat, thereby resulting in siloxane bonds.

Illustrative examples of inorganic nanoparticles useful in the facing layer of body members of the disclosure include aluminum oxide, antimony tin oxide, bismuth subsalicylate, boemite, calcium carbonate, calcium phosphate, cerium dioxide, graphene, halloysite, lanthanum boride, lithium carbonate, silver, amorphous silica, colloidal silica, silicon dioxide, titanium dioxide, zinc oxide, zirconium oxide or dioxide.

Suitable nanoparticles can be of many shapes including irregular and regular shapes, nanotubes, nanoplatelets, cylindrical, etc.

Suitable nanoparticles can be of a wide range of particle sizes (e.g., particle diameter). In some embodiments, the average primary particle size may be within a range from 1 nanometer (nm) to 100 nm. Particle sizes and particle size distributions may be determined in a known manner including, for example, by transmission electron microscopy (TEM). In some embodiments, nanoparticles can have a primary particle size ranging from 5 nm to 75 nm. In some embodiments, nanoparticles can have a primary particle size ranging from 10 nm to 30 nm. The term “primary particle size” refers to the average size of unagglomerated single particles.

Nanoparticles can be present in an amount effective to enhance the durability of the finished article. In certain embodiments, the cured polymeric matrix of the facing layer includes nanoparticles in an amount of at least 15 wt-%, based on total weight of the cured matrix and nanoparticles of the facing layer. In certain embodiments, the cured polymeric matrix of the facing layer includes nanoparticles in an amount of up to 85 wt-%, based on the total weight of the cured matrix and nanoparticles of the facing layer.

Typically, nanoparticles can be present in a coatable composition for making a facing layer in an amount from 10 wt-% to 95 wt-%, based on the total weight of the coatable composition. In some embodiments, nanoparticles can be present in a coatable composition for making a facing layer in an amount from 25 wt-% to 80 wt-%, based on the total weight of the coatable composition. In other embodiments, nanoparticles can be present in a coatable composition for making a facing layer in an amount from 30 wt-% to 70 wt-%, based on the total weight of the coatable composition.

Silica nanoparticles, such as fumed silica, are particularly desirable. Silica nanoparticles suitable for use in the articles of the present disclosure are commercially available from Nalco Chemical Co. (Naperville, Ill.) under the product designation NALCO Colloidal Silicas. Suitable silica products include NALCO Products 1040, 1042, 1050, 1060, 2327, and 2329. Suitable fumed silica products include products sold under the tradename AEROSIL series OX-50, -130, -150, and -200 from DeGussa AG, (Hanau, Germany), and CAB-O-SPERSE 2095, CAB-O-SPERSE A105, CAB-O-SIL MS from Cabot Corp. (Tuscola, Ill.).

Nanoparticles can be surface modified, which refers to the fact that the nanoparticles have a modified surface so that the nanoparticles provide a stable dispersion. “Stable dispersion” refers to a dispersion in which the colloidal nanoparticles do not agglomerate after standing for a period of time, such as 24 hours, under ambient conditions, e.g., room temperature, and atmospheric pressure, without extreme electromagnetic forces. Preferably, the surface-treatment stabilizes the nanoparticles so that the particles will be well dispersed in the coatable composition and result in a substantially homogeneous composition. Furthermore, the nanoparticles can be modified over at least a portion of its surface with a surface treatment agent so that the stabilized particle can copolymerize or react with the coatable composition during curing.

In certain embodiments of the disclosure, at least a portion of the nanoparticles may be surface modified. In other embodiments, all of the nanoparticles are surface modified. In still other embodiments, none of the nanoparticles are surface modified.

The surface-modified colloidal nanoparticles described herein can have a variety of desirable attributes, including, for example, nanoparticle compatibility with a coatable composition such that the nanoparticles form stable dispersions within the coatable composition, reactivity of the nanoparticle with the coatable composition making the article more durable, and a low impact or uncured composition viscosity. A combination of surface modifications can be used to manipulate the uncured and cured properties of the composition. Surface-modified nanoparticles can improve optical and physical properties of the coatable composition such as, for example, improved resin mechanical strength, minimized viscosity changes while increasing solids volume loading in the coatable composition and maintain optical clarity while increasing solid volume loading in the coatable composition.

Metal oxide nanoparticles can be treated with a surface treatment agent to make them “surface modified.” In general, a surface treatment agent has a first end that will attach to the particle surface (covalently, ionically, or through strong physiosorption) and a second end that imparts compatibility of the particle with the coatable composition and/or reacts with coatable composition during curing. Examples of surface treatment agents include alcohols, amines, carboxylic acids, sulfonic acids, phosphonic acids, silanes, and titanates. The type of treatment agent can depend on the nature of the metal oxide surface. For example, silanes are typically preferred for silica.

Surface treatment agents suitable for nanoparticles useful herein include compounds such as, for example, isooctyl trimethoxy-silane, N-(3-triethoxysilylpropyl) methoxyethoxyethoxyethyl carbamate (PEG3TES), SILQUEST A1230, N-(3-triethoxysilylpropyl) methoxyethoxyethoxyethyl carbamate (PEG2TES), 3-(methacryloyloxy)propyltrimethoxysilane, 3-acryloxypropyltrimethoxysilane, 3-(methacryloyloxy)propyltriethoxysilane, 3-(methacryloyloxy) propylmethyldimethoxysilane, 3-(acryloyloxypropyl)methyldimethoxysilane, 3-(methacryloyloxy)propyldimethylethoxysilane, 3-(methacryloyloxy) propyldimethylethoxysilane, vinyldimethylethoxysilane, phenyltrimethoxysilane, n-octyltrimethoxysilane, dodecyltrimethoxysilane, octadecyltrimethoxysilane, propyltrimethoxysilane, hexyltrimethoxysilane, vinylmethyldiacetoxysilane, vinylmethyldiethoxysilane, vinyltriacetoxysilane, vinyltriethoxysilane, vinyltriisopropoxysilane, vinyltrimethoxysilane, vinyltriphenoxysilane, vinyltri-t-butoxysilane, vinyltris-isobutoxysilane, vinyltriisopropenoxysilane, vinyltris(2-methoxyethoxy)silane, styrylethyltrimethoxysilane, mercaptopropyltrimethoxysilane, 3-glycidoxypropyltrimethoxysilane, acrylic acid, methacrylic acid, oleic acid, stearic acid, dodecanoic acid, 2-[2-(2-methoxyethoxy)ethoxy]acetic acid (MEEAA), beta-carboxyethylacrylate, 2-(2-methoxyethoxy)acetic acid, methoxyphenyl acetic acid, and mixtures of two or more of the foregoing.

Surface modification can be accomplished either prior to mixing into a coatable composition or after mixing. It may be preferred in the case of silanes to react the silanes with the nanoparticle surface before incorporation into the coatable composition. The amount of surface treatment agent can depend on factors such as particle size, particle type, modifier molecular weight, and modifier type. In general, a monolayer of modifier is attached to the surface of the particle. The attachment procedure or reaction conditions required also depend on the surface treatment agent used.

Surface modification of the particles in a colloidal dispersion can be accomplished in a number of ways. The process involves the mixture of an inorganic dispersion with surface treatment agents and, optionally, a co-solvent such as, for example, 1-methoxy-2-propanol, ethanol, isopropanol, ethylene glycol, N,N-dimethylacetamide and 1-methyl-2-pyrrolidinone. Co-solvent can be added to enhance the solubility of the surface treatment agents as well as the surface modified particles. The mixture comprising the inorganic sol and surface treatment agents is subsequently reacted at room or an elevated temperature, with or without mixing. For silanes, surface treatment may take place at elevated temperatures under acidic or basic conditions during a period of 1 hour up to 24 hours. In one method, the mixture can be reacted at 85° C. for 24 hours, resulting in a surface-modified sol. In one method, where metal oxides are surface-modified, the surface treatment of the metal oxide can involve the adsorption of acidic molecules to the particle surface. The surface modification of the heavy metal oxide preferably takes place at room temperature.

In some embodiments, a body member 12 is formed by applying a suitable curable coating composition to at least a portion of the front surface 17 of a base member 15 and curing the composition. In some embodiments, a body member may be preformed as a portion of a preformed writable and cleanable article 10 and then bonded to at least a portion of the front surface of a substrate (piece of furniture, door, window, vehicle, etc.), e.g., laminated or adhered to such substrate using a bonding adhesive or other tie layer, for example.

As will be understood, coating compositions used to make the facing layer of articles of the disclosure may include optional additives to enhance or control characteristics as desired, e.g., rheology modifiers such as JAYLINK Rheology Modifiers, colorants (e.g., dyes and/or pigments), fire retardants, antioxidants, stabilizers, antiozonants, plasticizers, UV absorbers, hindered amine light stabilizers (HALS), etc.

Coating compositions for making the facing layer may be coated out of one or more solvents.

Exemplary solvents include ketones and alcohols, such as methyl ethyl ketone, methoxy propanol, methoxy ethanol, and the like.

Coating compositions for making the facing layer are preferably coated on a base member using conventional techniques, such as bar, roll, curtain, rotogravure, spray, or dip coating techniques. The preferred methods include bar and roll coating, or air knife coating to adjust thickness. Once coated, a variety of curing strategies may be used as are well known to those skilled in the art.

As noted above, at least a portion of the front surface 16 of the body member 12, and in some instances essentially the entire front surface thereof, is siloxane-bondable, i.e., capable of forming siloxane bonds with a compatibly formulated overcoat. In some embodiments, siloxane-bondable capability of the body member is achieved by exposing siloxane-bondable nanoparticles in the cured polymeric matrix of the facing layer 13. Illustrative examples of methods of achieving this are treatment of the front surface 16 of the facing layer 13 (i.e., front surface 16 of the body member 12) with plasma etching, corona treatment, flame treatment, or otherwise surface treating the facing layer prior to applying an overcoat. Alternatively or additionally, a siloxane-bondable primer layer is disposed on the facing layer surface.

### Optional Primer Layer on Facing Layer

In certain embodiments, a primer layer is disposed between the facing layer 13 and the overcoat 14. Such primer layer may be a “diamond-like glass” layer or sintered silica layer, for example, disposed on the surface of the facing layer. Such primer layers are siloxane-bondable, typically because they provide —OH groups. Other primer compositions can be used to provide —OH groups. Examples of such compositions include a tetraalkoxysilane, oligomers thereof, lithium silicate, sodium silicate, potassium silicate, silica (e.g., silica particles), or combinations thereof. In certain embodiments, the surface 16 of the facing layer 13 can be surface modified by a conventional vapor coating or vapor deposition process to create SiO or SiO₂ thin layer primers described in U.S. Pat. No. 4,338,377 (Beck et al.). Surface modification of substrates may also include vapor coating or vapor deposition of alkoxysilanes.

Typically, although not required, the primer layer may be writable surface (i.e., writing surface), which is a surface on which can be written with a dry-erase marker, for example.

In certain embodiments, the primer layer is diamond-like glass. U.S. Pat. No. 6,696,157 (David et al.) discloses diamond-like glass (sometimes referred to as “DLG”) films and methods for making them, which can be used in making the primer layer of the present disclosure. An advantage of such materials is that in addition to providing the siloxane-bondable front surface on the body member which provides strong bonds to the overcoat, such layers can in addition provide stiffness and dimensional stability that serves to support the overlying overcoat, making the resultant writable and cleanable article more durable and resistant to marring. This is particularly helpful when the underlying components of the base member may be relatively softer.

Illustrative diamond-like glass materials suitable for use herein comprise a carbon-rich diamond-like amorphous covalent system containing carbon, silicon, hydrogen and oxygen. The DLG is created by depositing a dense random covalent system comprising carbon, silicon, hydrogen, and oxygen under ion bombardment conditions by locating a substrate on a powered electrode in a radio frequency (“RF”) chemical reactor. In specific implementations, DLG is deposited under intense ion bombardment conditions from mixtures of tetramethylsilane and oxygen. Typically, DLG shows negligible optical absorption in the visible and ultraviolet regions (i.e., 250 to 800 nm). Also, DLG usually shows improved resistance to flex-cracking compared to some other types of carbonaceous films and excellent adhesion to many substrates, including ceramics, glass, metals, and polymers.

DLG contains at least 30 atomic percent carbon, at least 25 atomic percent silicon, and less than or equal to 45 atomic percent oxygen. DLG typically contains from 30 to 50 atomic percent carbon. In specific implementations, DLG can include 25 to 35 atomic percent silicon. Also, in certain implementations, the DLG includes 20 to 40 atomic percent oxygen. In specific advantageous implementations the DLG comprises from 30 to 36 atomic percent carbon, from 26 to 32 atomic percent silicon, and from 35 to 41 atomic percent oxygen on a hydrogen free basis. “Hydrogen free basis” refers to the atomic composition of a material as established by a method such as Electron Spectroscopy for Chemical Analysis (ESCA), which does not detect hydrogen even if large amounts are present in the thin films.

In certain embodiments, the optional primer layer (e.g., DLG primer layer) disposed on the body member is from 0.1 micron to 2 microns thick, although other thicknesses may be used as desired.

In certain embodiments, the facing layer 13 of the body member 12 can be treated to improve adhesion of the DLG. Typically, such treatment includes plasma treatment.

### Overcoat

The overcoat 14 is typically formed by applying a curable liquid overcoating composition that includes a siloxane-bondable component over at least a portion of the front surface 16 of the body member 12. The coating composition is then cured such that a solid overcoat 14, which is siloxane-bonded to the facing layer 13 of the body member 12 and/or a siloxane-bondable primer layer disposed thereon, is formed.

The resultant construction (i.e., an overcoated body member, or a base member with a facing layer disposed on the base member and an overcoat disposed on the facing layer) has a writing surface (i.e., writable surface) 19 that is cleanable (e.g., with a dry eraser) and rewritable (e.g., with a dry erase marker).

The overcoat has a hydrophilic surface, preferably highly hydrophilic. As used herein, “hydrophilic” is used to refer to a surface that is wet by aqueous solutions, and does not express whether or not the layer absorbs aqueous solutions. Surfaces on which drops of water or aqueous solutions exhibit a static water contact angle of less than 50° are referred to as “hydrophilic” per ASTM D7334-08. In contrast, hydrophobic surfaces have a water contact angle of 50° or greater.

In certain embodiments, the hydrophilic overcoat includes sulfonate-functional groups, phosphate-functional groups, phosphonate-functional groups, phosphonic acid-functional groups, carboxylate-functional groups, or a combination thereof. In certain embodiments, the hydrophilic overcoat includes sulfonate-functional groups.

In illustrative embodiments, the resultant overcoat is applied in at least a monolayer thickness. As used herein, “at least a monolayer thickness” includes a monolayer or a thicker layer of molecules, covalently bonded (through siloxane bonds) to the underlying facing layer surface and/or primer on the facing layer surface.

In certain embodiments, an overcoat is at least 0.3 micron thick. Typically, an overcoat is no greater than 10 microns, and preferably no greater than 1 micron thick. Such thicknesses can be measured using an ellipsometer such as a Gaertner Scientific Corp Model No. L115C. It will be understood that articles of the disclosure can be made using other thicknesses of the overcoat layer.

In certain embodiments, the hydrophilic overcoat is formed from one or more zwitterionic compounds, such as zwitterionic silanes. Zwitterionic compounds are neutral compounds that have electrical charges of opposite sign within a molecule.

In some embodiments, the overcoat is formed from at least one zwitterionic silane selected from the group of phosphate-functional silanes, phosphonate-functional silanes, phosphonic acid-functional silanes, carboxylate-functional silanes, and sulfonate-functional silanes. Such silanes include groups (e.g., sulfonate group (SO₃⁻)) for imparting desired high hydrophilicity to the surface for providing suitable cleanability. Herein, silanes refer to silicon-containing compounds that have groups capable of forming siloxane bonds with the facing layer. Typically, such groups are alkoxysilane or silanol groups.

Illustrative examples of zwitterionic compounds include those disclosed in U.S. Publication No. 2017/0275495 (Riddle et al.).

In certain embodiments, the zwitterionic compound is a sulfonate-functional zwitterionic compound, such as a zwitterionic sulfonate-functional silane compound. In certain embodiments, the zwitterionic hydrophilic overcoat is derived from a zwitterionic compound comprising sulfonate-functional groups and alkoxysilane groups and/or silanol-functional groups.

In certain embodiments, the zwitterionic sulfonate-functional silane compounds used in making the overcoat of the present disclosure have the following Formula (I) wherein:

(R¹O)ₚ—Si(R²)_{q}—W—N⁺(R³)(R⁴)—(CH₂)ₘ—SO₃⁻ (I)

wherein:

each R¹ is independently a hydrogen, methyl group, or ethyl group;

each R² is independently hydroxyl, (C1-C4)alkyl groups, and (C1-C4)alkoxy groups, (preferably, a methyl group or an ethyl group);

each R³ and R⁴ is independently a saturated or unsaturated, straight chain, branched, or cyclic organic group (preferably having 20 carbons or less), which may be joined together, optionally with atoms of the group W, to form a ring;

W is an organic linking group;

p is an integer of 1 to 3;

m is an integer of 1 to 10 (preferably, 1 to 4);

q is 0 or 1; and

p+=3.

The organic linking group W of Formula (I) is preferably selected from saturated or unsaturated, straight chain, branched, or cyclic organic groups. The linking group W is preferably an alkylene group, which may include carbonyl groups, urethane groups, urea groups, heteroatoms such as oxygen, nitrogen, and sulfur, and combinations thereof. Examples of suitable linking groups W include alkylene groups, cycloalkylene groups, alkyl-substituted cycloalkylene groups, hydroxy-substituted alkylene groups, hydroxy-substituted mono-oxa alkylene groups, divalent hydrocarbon groups having mono-oxa backbone substitution, divalent hydrocarbon groups having mono-thia backbone substitution, divalent hydrocarbon groups having monooxo-thia backbone substitution, divalent hydrocarbon groups having dioxo-thia backbone substitution, arylene groups, arylalkylene groups, alkylarylene groups and substituted alkylarylene groups.

Suitable examples of zwitterionic compounds of Formula (I) are described in U.S. Pat. No. 5,936,703 (Miyazaki et al.) and International Publication Nos. WO 2007/146680 (Schlenoff) and WO 2009/119690 (Yamazaki et al.), and include the following zwitterionic functional groups (—W—N⁺(R³)(R⁴)—(CH₂)ₘ—SO₃⁻):

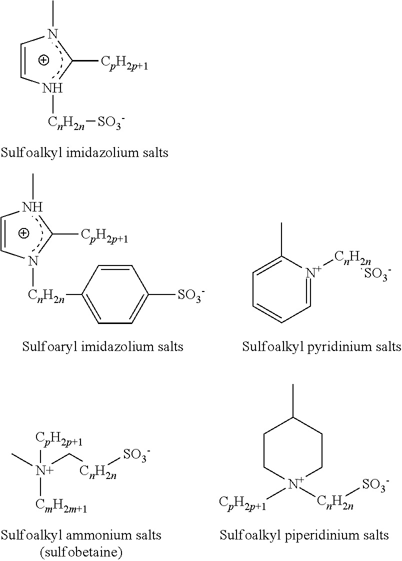

In certain embodiments, the sulfonate-functional silane compounds used in making the overcoat of the present disclosure have the following Formula (II) wherein:

(R¹O)ₚ—Si(R²)_{q}—CH₂CH₂CH₂—N⁺(CH₃)₂—(CH₂)ₘ—SO₃⁻ (II)

wherein:

each R¹ is independently a hydrogen, methyl group, or ethyl group;

each R² is independently hydroxyl, (C1-C4)alkyl groups, and (C1-C4)alkoxy groups, (preferably, a methyl group or an ethyl group);

p is an integer of 1 to 3;

m is an integer of 1 to 10 (preferably, 1 to 4);

q is 0 or 1; and

p+q=3.

Suitable examples of zwitterionic compounds of Formula (II) are described in U.S. Pat. No. 5,936,703 (Miyazaki et al.), including, for example:
(CH₃O)₃Si—CH₂CH₂CH₂—N⁺(CH₃)₂—CH₂CH₂CH₂—SO₃⁻; and
(CH₃CH₂O)₂Si(CH₃)—CH₂CH₂CH₂—N⁺(CH₃)₂—CH₂CH₂CH₂—SO₃⁻.

Other examples of suitable zwitterionic compounds, which can be made using standard techniques known to those skilled in the art, include the following:

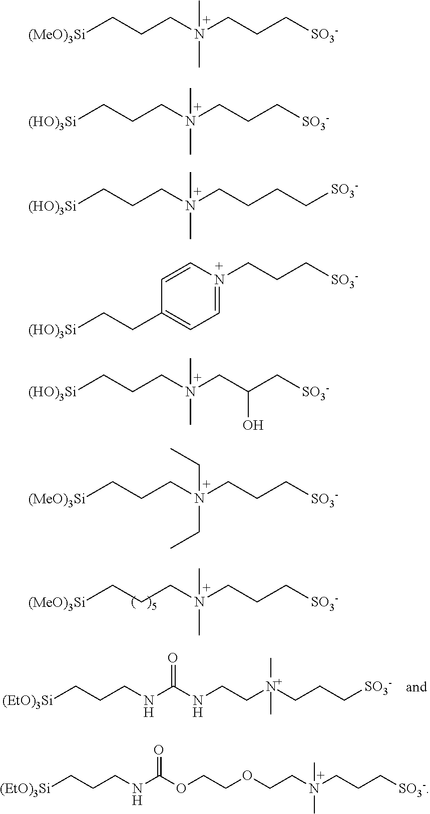

While the following refers to sulfonate-functional coating compositions for making an overcoat of a writable and cleanable article as described herein, such disclosure also applies to other coating compositions using other hydrophilic coating compositions (e.g., other zwitterionic compounds such as phosphate-functional compounds).

A sulfonate-functional coating composition for making an overcoat of a writable and cleanable article of the present disclosure typically includes a sulfonate-functional compound in an amount of at least 0.1 wt-%, and often at least 1 wt-%, based on the total weight of the coating composition. A sulfonate-functional coating composition for making an overcoat of a writable and cleanable article of the present disclosure typically includes a sulfonate-functional compound in an amount of no greater than 20 wt-%, and often no greater than 5 wt-%, based on the total weight of the coating composition. Generally, for monolayer coating thicknesses, relatively dilute coating compositions are used. Alternatively, relatively concentrated coating compositions can be used and subsequently rinsed.

A sulfonate-functional coating composition for making an overcoat of a writable and cleanable article of the present disclosure preferably includes alcohol, water, or hydroalcoholic solutions (i.e., alcohol and/or water). Typically, such alcohols are lower alcohols (e.g., (C1-C8)alcohols, and more typically (C1-C4)alcohols), such as methanol, ethanol, propanol, 2-propanol, etc. Preferably, sulfonate-functional coating compositions are aqueous solutions. As it is used herein, the term “aqueous solution” refers to solutions containing water. Such solutions may employ water as the only solvent or they may employ combinations of water and organic solvents such as alcohol and acetone. Organic solvents may also be included in the hydrophilic treatment compositions so as to improve their freeze-thaw stability. Typically, the solvents are present in an amount up to 50 wt-% of the compositions and preferably in the range of 5 to 50 wt-% of the compositions.

A sulfonate-functional coating composition for making an overcoat of a writable and cleanable article of the present disclosure can be acidic, basic, or neutral. The performance durability of the coatings can be affected by pH. For example, coating compositions containing sulfonate-functional zwitterionic compounds are preferably neutral.

A sulfonate-functional coating composition for making an overcoat of a writable and cleanable article of the present disclosure may be provided in a variety of viscosities. Thus, for example, the viscosity may vary from a water-like thinness to a paste-like heaviness. They may also be provided in the form of gels.

Useful coating compositions include greater than 1 wt-%, greater than 2 wt-% solids, or at least 3 wt-% solids, and often up to 20 wt-% solids. Solids typically means the components other than water.

Additionally, a variety of other ingredients may be incorporated in the compositions for making an overcoat of a writable and cleanable article of the present disclosure. Thus, for example, conventional surfactants, cationic, anionic, or nonionic surfactants can be used. Detergents and wetting agents can also be used. At least one of a water soluble alkali metal silicate, a tetraalkoxysilane monomer, a tetraalkoxysilane oligomer, and an inorganic silica sol can be used if desired. In certain embodiments, a hydrophilic overcoat further comprises a water soluble alkali metal silicate, particularly lithium silicate. Such additional ingredients used in making the overcoat are described below for the Cleaning and Protecting Composition. In certain embodiments, however, the compositions used to form the overcoat do not include surfactants.

Sulfonate-functional coating compositions are preferably coated on a body member using conventional techniques, such as bar, roll, curtain, rotogravure, spray, or dip coating techniques. The preferred methods include bar and roll coating, or air knife coating to adjust thickness.

Once coated, the sulfonate-functional composition is typically dried at temperatures of 20° C. to 150° C. in a recirculating oven. An inert gas may be circulated. The temperature may be increased further to speed the drying process, but care must be exercised to avoid damage to the substrate.

Such hydrophilic overcoat provides a cleanable surface such that the articles described herein can be readily cleaned, e.g., by simply wiping with a dry cloth, paper towel, etc., or in some instances, by wiping with a cloth, paper towel, etc., using water.

For instance, in embodiments where the article is a dry erase article, the surface of the overcoat can be readily written on, then easily cleaned. Significantly, even permanent marker writing can be easily removed with wiping, preferably after first applying water and/or water vapor (e.g., by breathing). Typically, methods of the present disclosure include removing permanent marker writing from the surface by simply applying water (e.g., tap water at room temperature) and/or water vapor (e.g., a person's breath) and wiping. As used herein, “wiping” refers to gentle wiping, typically by hand, with for example, a tissue, paper towel, or a cloth, without significant pressure (e.g., generally, no more than 350 grams) for one or more strokes or rubs (typically, only a few are needed).

In some instances, cleaning the surface, e.g., erasing the dry erase board, is facilitated by using a cleaner composition, preferably a Cleaning and Protecting Composition as described below.

### Cleaning and Protecting Compositions

Cleaning and protecting compositions of the present disclosure have multiple functions, i.e., they are multi-functional compositions. The compositions exhibit multiple functions in that they remove an unwanted constituent from the substrate surface, impart a hydrophilic property to the substrate surface, and impart an easy to clean property to the substrate surface. That is, they are capable of cleaning and protecting a substrate surface to which applied. In this context, protection typically means that one or more contaminants (e.g., dry erase marker) are easier to remove after application of the composition to the substrate surface, for example, of a writable and cleanable article.

Writable and cleanable articles described herein can be easily and effectively cleaned repeatedly, however, even such advantageous properties can be exhausted due to depletion of the surface layer(s) that make them writable and cleanable. Surprisingly, such compositions also restore performance, particularly with respect to cleanability, and in some embodiments, with respect to writability, to that of (or close to that of) an original, un-used writable and cleanable article.

For films applied to a vehicle, this is particularly advantageous. For example, many vehicles such as buses and train cars, are frequently defaced using by vandals using, e.g., spray paint or markers. Certain commercially available surface protection films use low surface energy components that make the films un-writable. It is believed that the vandal will choose a different method (scratch or gouge) to deface a surface if their paint does not stick in the manner that they desire. Thus, a writable surface allows the vandal to deface the surface without knowing their mark is easily removed. The surface could be easily cleaned by rain, brushing, or an automated vehicle wash system. Thus, the writable and cleanable articles described herein are particularly advantageous for use on vehicles that are easily defaced.

Such compositions can be dispersions or solutions. They typically include a hydrophilic silane, a surfactant, and water.

Such composition can be applied to a clean surface, a surface that is soiled, a surface that includes irregularities and defects, a previously cleaned surface, and combinations thereof, and can be used repeatedly. Typically, such composition is applied to a surface of an writable and cleanable article as described herein wherein the hydrophilic overcoat has an at least partially depleted hydrophilic surface. Such depletion adversely impacts the cleanability of the surface, and may even adversely impact the writability of the surface. Use of the cleaning and protecting composition on a writable surface increases the amount of hydrophilic silane on the surface and increases the hydrophilicity of the surface, thereby replenishing the hydrophilic overcoat and restoring cleanability, and may even restore the writability, of the surface.

Such composition also preferably imparts a sufficient hydrophilic property to a surface such that when the surface is subsequently marked with a permanent marker, the mark can be substantially removed, or even completely removed, from the surface with at least one of water (e.g., tap water at ambient temperature), water vapor (e.g., an individual's breath), wiping (e.g., up to a few gentle strokes with a tissue, paper towel, cloth), a cleaning composition, and combinations thereof (e.g., by spraying the surface and the mark with water and then wiping).

In certain embodiments, a cleaning and protecting composition preferably includes an amount of hydrophilic silane and an amount of surfactant such that ratio of the weight of the hydrophilic silane to the weight of the surfactant in the composition is at least 1:1, at least 1:2, at least 1:3, at least 1:10, at least 1:40, or at least 1:400. That is, in such compositions the amount of surfactant is equal to or greater than the amount of hydrophilic silane. In certain embodiments, a cleaning and protecting composition preferably includes an amount of hydrophilic silane and an amount of surfactant such that ratio of the weight of the hydrophilic silane to the weight of the surfactant in the composition is from 1:2 to 1:100, or even from 1:3 to at 1:20. This composition is typically more useful on a surface that is regularly cleaned, which is not subject to build-up of contaminants, so protection is not critical, but repeated use can provide protection and make the surface easier to clean.

A cleaning and protecting composition can be acidic, basic, or neutral. The pH of the composition can be altered to achieve the desired pH using any suitable acid or base as is known in the art, including, e.g., organic acids and inorganic acids, or carbonates, such as potassium or sodium carbonate. Compositions that include sulfonate-functional zwitterionic compounds have a pH of from 5 to 8, are neutral, or even are at their isoelectric point.

A cleaning and protecting composition can be provided in a variety of forms including, e.g., as a concentrate that is diluted before use (e.g., with water, a solvent or an aqueous-based composition that includes an organic solvent) or as a ready-to-use composition, a liquid, a paste, a foam, a foaming liquid, a gel, and a gelling liquid. The multi-functional composition has a viscosity suitable for its intended use or application including, e.g., a viscosity ranging from a water-like thinness to a paste-like heaviness at 22° C. (72° F.).

In certain embodiments, useful cleaning and protecting compositions include no greater than 2 wt-% solids, or even no greater than 1 wt-% solids, and often at least 0.05 wt-% solids. Solids typically means the components other than water.

### Hydrophilic Silane of Cleaning and Protecting Composition

Suitable hydrophilic silanes are preferably water soluble, and in some embodiments, suitable hydrophilic silanes are nonpolymeric compounds. They are siloxane-bondable, i.e., capable of forming siloxane bonds to the overcoat, facing layer, and/or optional primer layer.

Useful hydrophilic silanes include, e.g., individual molecules, oligomers (typically less than 100 repeat units, and often only a few repeat units) (e.g., monodisperse oligomers and polydisperse oligomers), and combinations thereof, and preferably have a number average molecular weight no greater than (i.e., up to) 5000 grams per mole (g/mole), no greater than 3000 g/mole, no greater than 1500 g/mole, no greater than 1000 g/mole or even no greater than 500 g/mole. The hydrophilic silane optionally is a reaction product of at least two hydrophilic silane molecules.

These typically are selected to provide protectant properties to a composition of the present disclosure. The hydrophilic silane can be any one of a variety of different classes of hydrophilic silanes including, e.g., zwitterionic silanes, non-zwitterionic silanes (e.g., cationic silanes, anionic silanes and nonionic silanes), silanes that include functional groups (e.g., functional groups attached directly to a silicon molecule, functional groups attached to another molecule on the silane compound, and combinations thereof), and combinations thereof. Useful functional groups include, e.g., alkoxysilane groups, siloxy groups (e.g., silanol), hydroxyl groups, sulfonate groups, phosphonate groups, carboxylate groups, gluconamide groups, sugar groups, polyvinyl alcohol groups, quaternary ammonium groups, halogens (e.g., chlorine and bromine), sulfur groups (e.g., mercaptans and xanthates), color-imparting agents (e.g., ultraviolet agents (e.g., diazo groups) and peroxide groups), click reactive groups, bioactive groups (e.g., biotin), and combinations thereof.

Examples of suitable classes of hydrophilic silanes that include functional groups include sulfonate-functional zwitterionic silanes, sulfonate-functional non-zwitterionic silanes (e.g., sulfonated anionic silanes, sulfonated nonionic silanes, and sulfonated cationic silanes), hydroxyl sulfonate silanes, phosphonate silanes (e.g., 3-(trihydroxysilyl)propyl methyl-phosphonate monosodium salt), carboxylate silanes, gluconamide silanes, polyhydroxyl alkyl silanes, polyhydroxyl aryl silanes, hydroxyl polyethyleneoxide silanes, polyethyleneoxide silanes, and combinations thereof.

Useful sulfonate-functional zwitterionic silanes are those of Formulas (I) and (II) as described above for the overcoat of the writable and cleanable article.

A useful class of sulfonate-functional non-zwitterionic silanes has the following Formula (III):

[(MO)(Qₙ)Si(XCH₂SO₃⁻)₃₋ₙ]Y_{2/nr}^{+r} (III)

wherein:

each Q is independently selected from hydroxyl, alkyl groups containing from 1 to 4 carbon atoms, and alkoxy groups containing from 1 to 4 carbon atoms;

M is selected from hydrogen, alkali metals, and organic cations of strong organic bases having an average molecular weight of less than 150 and a pKa of greater than 11;

X is an organic linking group;

Y is selected from hydrogen, alkaline earth metals, organic cations of protonated weak bases having an average molecular weight of less than 200 and a pKa of less than 11, alkali metals, and organic cations of strong organic bases having an average molecular weight of less than 150 and a pKa of greater than 11, provided that when Y is hydrogen, alkaline earth metals or an organic cation of a protonated weak base, M is hydrogen;

r is equal to the valence of Y; and

n is 1 or 2.

Preferred non-zwitterionic silanes of Formula (III) include alkoxysilane compounds in which Q is an alkoxy group containing from 1 to 4 carbon atoms.

The silanes of Formula (III) preferably include is at least 30 wt-%, at least 40 wt-%, or even from 45 wt-% to 55 wt-%, and no greater than 15 wt-%, based on the weight of the compound in the water-free acid form.

Useful organic linking groups X of Formula (III) include, e.g., alkylenes, cycloalkylenes, alkyl-substituted cycloalkylenes, hydroxy-substituted alkylenes, hydroxy-substituted mono-oxa alkylenes, divalent hydrocarbons having mono-oxa backbone substitution, divalent hydrocarbons having mono-thia backbone substitution, divalent hydrocarbons having monooxo-thia backbone substitution, divalent hydrocarbons having dioxo-thia backbone substitution, arylenes, arylalkylenes, alkylarylenes, and substituted alkylarylens.

Examples of useful Y groups of Formula (III) include 4-aminopyridine, 2-methoxyethylamine, benzylamine, 2,4-dimethylimidazole, and 3-[2-ethoxy(2-ethoxyethoxy)]propylamine, ⁺N(CH₃)₄, and ⁺N(CH₂CH₃)₄.

Suitable sulfonate-functional non-zwitterionic silanes of Formula (III) include, e.g., (HO)₃Si—CH₂CH₂CH₂—O—CH₂—CH(OH)—CH₂SO₃—H⁺; (HO)₃Si—CH₂CH(OH)—CH₂SO₃—H⁺; (HO)₃Si—CH₂CH₂CH₂SO₃—H⁺; (HO)₃Si—C₆H₄—CH₂CH₂SO₃—H⁺; (HO)₂Si—[CH₂CH₂SO₃—H⁺]₂; (HO)—Si(CH₃)₂—CH₂CH₂SO3-H⁺; (NaO)(HO)₂Si—CH₂CH₂CH₂—O—CH₂—CH(OH)—CH₂SO₃—Na⁺; and (HO)₃Si—CH₂CH₂SO₃—K⁺ and those sulfonate-functional non-zwitterionic silanes of Formula (III) described in U.S. Pat. No. 4,152,165 (Langager et al.) and U.S. Pat. No. 4,338,377 (Beck et al).

A cleaning and protecting composition preferably includes at least 0.0001 wt-%, at least 0.001 wt-%, or in certain embodiments at least 0.005 wt-%, at least 0.01 wt-%, or at least 0.05 wt-%, hydrophilic silane. A cleaning and protecting composition preferably includes up to 10 wt-%, or in certain embodiment no greater than 3 wt-%, no greater than 2 wt-%, no greater than 1.5 wt-%, no greater than 1 wt-%, no greater than 0.75 wt-%, or even no greater than 0.5 wt-%, hydrophilic silane. The hydrophilic silane optionally is provided in a concentrated form that can be diluted to achieve the percent by weight hydrophilic silane set forth above.

### Surfactant in Cleaning and Protecting Composition

Suitable surfactants include, e.g., anionic, nonionic, cationic, and amphoteric surfactants, and combinations thereof. These can provide cleaning properties, wetting properties, or both to a composition of the present disclosure.

A cleaning and protecting composition may contain more than one surfactant. One or more surfactants is typically selected to function as a cleaning agent. One or more surfactants is typically selected to function as a wetting agent. The cleaning agent(s) can be a detergents, foaming agents, dispersants, emulsifiers, or combinations thereof. The surfactants in such cleaning agents typically include both a hydrophilic portion that is anionic, cationic, amphoteric, quaternary amino, or zwitterionic, and a hydrophobic portion that includes a hydrocarbon chain, fluorocarbon chain, siloxane chain, or combinations thereof. The wetting agent(s) can be selected from a wide variety of materials that lowers the surface tension of the composition. Such wetting agents typically include a non-ionic surfactant, hydrotrope, hydrophilic monomer or polymer, or combinations thereof.

In certain embodiments of a cleaning and protecting composition, one surfactant can be an anionic surfactant and one can be a nonionic surfactant.

Useful anionic surfactants include surfactants having a molecular structure that includes: (1) at least one hydrophobic moiety (e.g., an alkyl group having from 6 to 20 carbon atoms in a chain, alkylaryl group, alkenyl group, and combinations thereof), (2) at least one anionic group (e.g., sulfate, sulfonate, phosphate, polyoxyethylene sulfate, polyoxyethylene sulfonate, polyoxyethylene phosphate, and combinations thereof), (3) salts of such anionic groups (e.g., alkali metal salts, ammonium salts, tertiary amino salts, and combinations thereof), and combinations thereof.

Useful anionic surfactants include, e.g., fatty acid salts (e.g., sodium stearate and sodium dodecanoate), salts of carboxylates (e.g., alkylcarboxylates (carboxylic acid salts) and polyalkoxycarboxylates, alcohol ethoxylate carboxylates, and nonylphenol ethoxylate carboxylates); salts of sulfonates (e.g., alkylsulfonates (alpha-olefinsulfonate), alkylbenzenesulfonates (e.g., sodium dodecylbenzenesulfonate), alkylarylsulfonates (e.g., sodium alkylarylsulfonate), and sulfonated fatty acid esters); salts of sulfates (e.g., sulfated alcohols (e.g., fatty alcohol sulfates, e.g., sodium lauryl sulfate), salts of sulfated alcohol ethoxylates, salts of sulfated alkylphenols, salts of alkylsulfates (e.g., sodium dodecyl sulfate), sulfosuccinates, and alkylether sulfates), aliphatic soap, fluorosurfactants, anionic silicone surfactants, and combinations thereof.

Suitable commercially available anionic surfactants include sodium lauryl sulfate surfactants available under the trade designations TEXAPON L-100 from Henkel Inc. (Wilmington, Del.) and STEPANOL WA-EXTRA from Stepan Chemical Co. (Northfield, Ill.), sodium lauryl ether sulfate surfactants available under the POLYSTEP B-12 trade designation from Stepan Chemical Co., ammonium lauryl sulfate surfactants available under the trade designation STANDAPOL A from Henkel Inc., sodium dodecyl benzene sulfonate surfactants available under the trade designation SIPONATE DS-10 from Rhone—Poulenc, Inc. (Cranberry, N.J.), decyl(sulfophenoxy)benzenesulfonic acid disodium salt available under the trade designation DOWFAX C10L from The Dow Chemical Company (Midland, Mich.).

Useful amphoteric surfactants include, e.g., amphoteric betaines (e.g., cocoamidopropyl betaine), amphoteric sultaines (cocoamidopropyl hydroxysultaine and cocoamidopropyl dimethyl sultaine), amphoteric imidazolines, and combinations thereof. A useful cocoamidopropyl dimethyl sultaine is commercially available under the LONZAINE CS trade designation from Lonza Group Ltd. (Basel, Switzerland). Useful coconut-based alkanolamide surfactants are commercially available from Mona Chemicals under the MONAMID 150-ADD trade designation). Other useful commercially available amphoteric surfactants include, e.g., caprylic glycinate (an example of which is available under the REWOTERIC AMV trade designation from Witco Corp.) and capryloamphodipropionate (an example of which is available under the AMPHOTERGE KJ-2 trade designation from Lonza Group Ltd.

Examples of useful nonionic surfactants include polyoxyethylene glycol ethers (e.g., octaethylene glycol monododecyl ether, pentaethylene monododecyl ether, poly-oxyethylenedodecyl ether, polyoxyethylenehexadecyl ether), polyoxyethylene glycol alkylphenol ethers (e.g., polyoxyethylene glycol octylphenol ether and polyoxyethylene glycol nonylphenol ether), polyoxyethylene sorbitan monoleate ether, polyoxyethylenelauryl ether, polyoxypropylene glycol alkyl ethers, glucoside alkyl ethers (e.g., decyl glucoside, lauryl glucoside, and octyl glucoside), glycerol alkyl esters, polyoxyethylene glycol sorbitan alkyl esters, monodecanoyl sucrose, cocamide, dodecyldimethylamine oxide, alkoxylated alcohol nonionic surfactants (e.g., ethoxylated alcohol, propoxylated alcohol, and ethoxylated-propoxylated alcohol). Useful nonionic surfactants include alkoxylated alcohol commercially available under the trade designations NEODOL 23-3 and NEODOL 23-5 from Shell Chemical LP (Houston, Tex.) and the trade designation IGEPAL CO-630 from Rhone-Poulenc, lauramine oxide commercially available under the BARLOX LF trade designation from Lonza Group Ltd. (Basel, Switzerland), and alkyl phenol ethoxylates and ethoxylated vegetable oils commercially available under the trade designation EMULPHOR EL-719 from GAF Corp. (Frankfort, Germany).

Examples of useful cationic surfactants include dodecyl ammonium chloride, dodecyl ammonium bromide, dodecyl trimethyl ammonium bromide, dodecyl pyridinium chloride, dodecyl pyridinium bromide, hexadecyl trimethyl ammonium bromide, cationic quaternary amines, and combinations thereof.

Other useful surfactants are disclosed, e.g., in U.S. Pat. No. 6,040,053 (Scholz et al).

The surfactant preferably is present in a cleaning and protecting composition in an amount sufficient to reduce the surface tension of the composition relative to the composition without the surfactant and to clean the surface. A cleaning and protecting composition preferably includes at least 0.02 wt-%, or at least 0.03 wt-%, or at least 0.05 wt-%, or at least 10 wt-%, surfactant. A cleaning and protecting composition preferably includes no greater than 0.4 wt-%, or no greater than 0.25 wt-%, surfactant. In certain embodiments, a cleaning and protecting composition preferably includes from 0.05 wt-% to 0.2 wt-%, or from 0.07 wt-% to 0.15 wt-%, surfactant.

### Water

The amount of water present in a cleaning and protecting composition varies depending upon the purpose and form of the composition. A cleaning and protecting composition can be provided in a variety of forms including, e.g., as a concentrate that can be used as is, a concentrate that is diluted prior to use, and as a ready-to-use composition. Useful concentrate compositions include at least 60 wt-%, at least 65 wt-%, or at least 70 wt-%, water. Useful concentrate compositions include no greater than 97 wt-%, no greater than 95 wt-%, or no greater than 90 wt-%. In certain embodiments, useful concentrate compositions include from 75 wt-% to 97 wt-%, or even from 75 wt-% to 95 wt-%.

Useful ready-to-use compositions include at least 70 wt-%, at least 80 wt-%, at least 90 wt-%, at least 95 wt-%, from 80 wt-% to 99.75 wt-%, or even from 80 wt-% to 97 wt-%, water.

### Optional Components in a Cleaning and Protecting Composition

A cleaning and protecting composition optionally includes one or more silicates, polyalkoxy silanes, or combinations thereof. These components can provide cleaning capability (e.g., as a result of increasing the pH of the composition). They can also provide protection (e.g., as a result of crosslinking).

Typically, the silicates are water soluble, and preferably a water soluble alkali metal silicate. Examples of suitable water soluble alkali metal silicates include lithium silicate, sodium silicate, potassium silicate, alkyl polysilicates and combinations thereof.

The water soluble alkali metal silicate, when present in the composition, is preferably present in an amount of at least 0.0001 wt-%, at least 0.001 wt-%, at least 0.01 wt-%, at least 0.02 wt-%, at least 0.05 wt-%, at least 0.1 wt-%, or at least 0.2 wt-%. The water soluble alkali metal silicate, when present in the composition, is preferably present in an amount of no greater than 10 wt-%, or no greater than 5 wt-%. In certain embodiments, the water soluble alkali metal silicate is present in an amount of from 0.02 wt-% to 1 wt-%, at or even from 0.1 wt-% to 0.5 wt-%.

Generally, the polyalkoxy silanes are less hydrophilic than the hydrophilic silanes described herein. They may be water soluble, alcohol soluble, or both. Examples of suitable polyalkoxy silanes include poly(diethoxysiloxane), tetraalkoxysilanes (e.g., tetraethylorthosilicate (TEOS) and oligomers of tetraalkoxysilanes), and combinations thereof.

The polyalkoxy silane, when present in the composition, is preferably present in an amount of at least 0.0001 wt-%, at least 0.001 wt-%, at least 0.01 wt-%, at least 0.02 wt-%, at least 0.05 wt-%, at least 0.1 wt-%, or at least 0.2 wt-%. The polyalkoxy silane, when present in the composition, is preferably present in an amount of no greater than 10 wt-%, or no greater than 5 wt-%. In certain embodiments, the polyalkoxy silane, when present in the composition, is preferably present in an amount of from 0.02 wt-% to 1 wt-%, at or even from 0.1 wt-% to 0.5 wt-%.

A cleaning and protecting composition may also optionally include an inorganic sol, e.g., a silica sol, an alumina sol, a zirconium sol, and combinations thereof. Examples of useful silica sols include aqueous inorganic silica sols and non-aqueous silica sols. A variety of inorganic silica sols in aqueous media are suitable including, e.g., silica sols in water and silica sols in water-alcohol solutions. Useful inorganic sols are commercially available under the trade designations LUDOX from E.I. duPont de Nemours and Co., Inc. (Wilmington, Del.), NYACOL from Nyacol Co. (Ashland, Me.) and NALCO from Ondea Nalco Chemical Co. (Oak Brook, Ill.). One useful silica sol is NALCO 2326 silica sol having a mean particle size of 5 nanometers, pH 10.5, and solid content of 15 wt-%. Other useful commercially available silica sols are available under the trade designations NALCO 1115 and NALCO 1130 from Nalco Chemical Co. (Naperville, Ill.), REMASOL SP30 from Remet Corp., LUDOX SM from E.I. Du Pont de Nemours Co., Inc., and SNOWTEX ST-OUP, SNOWTEX ST-UP, and SNOWTEX ST-PS-S from Nissan Chemical Co.

Useful non-aqueous silica sols (also called silica organosols) include sol dispersions in which the liquid phase is an organic solvent, or an aqueous organic solvent. The particles of the sol are preferably nano-sized particles. Sodium stabilized silica nanoparticles are preferably acidified prior to dilution with an organic solvent such as ethanol. Dilution prior to acidification may yield poor or non-uniform coatings. Ammonium stabilized silica nanoparticles may generally be diluted and acidified in any order.

When present, a cleaning and protecting composition preferably includes at least 0.005 wt-%, at least 0.01 wt-%, or at least 0.05 wt-%, inorganic sol (e.g., inorganic silica sol). When present, a cleaning and protecting composition preferably includes no greater than 3 wt-%, no greater than 2 wt-%, no greater than 1.5 wt-%, or even no greater than 1 wt-%, inorganic sol (e.g., inorganic silica sol).

A cleaning and protecting composition ma also optionally include water insoluble abrasive particles, organic solvents (e.g., water soluble solvents), detergents, chelating agents (e.g., EDTA (ethylene diamine tetra acetate), sodium citrate, and zeolite compounds), fillers, abrasives, thickening agents, builders (e.g., sodium tripolyphosphate, sodium carbonate, sodium silicate, and combinations thereof), sequestrates, bleach (e.g., chlorine, oxygen (i.e., non-chlorine bleach), and combinations thereof), pH modifiers, antioxidants, preservatives, fragrances, colorants (e.g., dyes), and combinations thereof.

Examples of suitable water insoluble abrasive particles include silica (e.g., silica particles, e.g., silica nanoparticles), perlite, calcium carbonate, calcium oxide, calcium hydroxide, pumice, and combinations thereof.

The water insoluble particles, when present in the composition, are preferably present in an amount of from 0.1 wt-% to 40 wt-%, from 0.1 wt-% to 10 wt-%, or even from 1 wt-% to 5 wt-%.

A cleaning and protecting composition may also optionally include an organic solvent. When a cleaning and protecting composition is a concentrate, the composition optionally is diluted with an organic solvent or a mixture of organic solvent and water. Useful organic solvents include, e.g., alcohols (e.g., methanol, ethanol, isopropanol, 2-propanol, 1-methoxy-2-propanol, 2-butoxyethanol, and combinations thereof), d-limonene, monoethanolamine, diethylene glycol ethyl ether, tripropylene glycol monomethyl ether, dipropylene glycol n-propyl ether, acetone, and combinations thereof.

When present, a cleaning and protecting composition includes no greater than 50 wt-%, from 0.1 wt-% to 30 wt-%, from 0.2 wt-% to 10 wt-%, or even from 0.5 wt-% to 5 wt-%, organic solvent.

Thickening agents can help to thicken the composition and may also be utilized where there is a need to increase the time the consumer can wipe the composition before it runs down a vertical surface. Examples of useful thickening agents include polyacrylic acid polymers and copolymers (examples of which are available under the CARBOPOL ETD 2623 trade designation from B.F. Goodrich Corporation (Charlotte, N.C.) and the ACCUSOL 821 trade designation from Rohm and Haas Company (Philadelphia, Pa.), hydroxymethyl cellulose, hydroxyethyl cellulose, hydroxypropyl cellulose, and combinations thereof.

### Kits

The present disclosure also provides kits that include writable and cleanable articles and cleaning and protecting compositions in any suitable packaging. For example, a cleaning and protecting composition may be packaged in a vessel equipped with a dispenser (e.g., a plastic bottle equipped with a sprayer or spray pump in a ready to use form), or in a vessel from which the composition can be transferred into another vessel or in which the composition can be diluted, e.g., when the composition is in the form of a concentrate.

A writable and cleanable article as described herein is included within a kit of the present disclosure. In certain embodiments, the writable and cleanable article 10 includes: a base member 12 having a front surface 17; a facing layer 13 that includes a cured polymeric matrix (organic or inorganic polymeric matrix) and a plurality of inorganic nanoparticles dispersed in the cured polymeric matrix, wherein the facing layer is disposed on at least a portion of the base member front surface; an optional primer layer (not shown) disposed on at least a portion of the facing layer 13; and a hydrophilic overcoat 14 bonded to the facing layer 13 and/or the optional primer layer through siloxane bonds; wherein the hydrophilic overcoat provides a writable and cleanable surface. In certain embodiments, article 10 further includes adhesive layer 18 and removable liner 20 on the back surface 22 of body member 12.

Examples of suitable adhesives include any of a wide variety. Adhesives are typically selected based upon the type of substrate to which they are adhered. The adhesives may be polymers that are dispersed in solvent or water and coated onto the release liner and dried, and optionally crosslinked. If a solvent-borne or water-borne pressure sensitive adhesive composition is employed, then the adhesive layer typically undergoes a drying step to remove all or a majority of the carrier liquid. Additional coating steps may be necessary to achieve a smooth surface. The adhesives may also be hot melt coated onto the liner or microstructured backing. Additionally, monomeric pre-adhesive compositions can be coated onto the liner and polymerized with an energy source such as heat, UV radiation, or e-beam radiation.

The thickness of the adhesive is dependent upon several factors, including for example, the adhesive composition, the type of structures used to form the microstructured surface, the type of substrate, and the thickness of the film. Those skilled in the art are capable of adjusting the thickness to address specific application factors.

Preferred adhesives are pressure sensitive adhesives. Classes of pressure sensitive adhesives include acrylics, tackified rubber (natural or synthetic), ethylene vinyl acetate, silicone, and the like. Suitable acrylic adhesives are disclosed, for example, in U.S. Pat. No. 3,239,478 (Harlan), U.S. Pat. No. 3,935,338 (Robertson), U.S. Pat. No. 4,952,650 (Young et al.), U.S. Pat. No. 4,181,752 (Martens et al.), U.S. Pat. No. 5,169,727 (Boardman), U.S. Pat. No. RE 24,906 (Uhlrich). A preferred class of pressure sensitive adhesives are the reaction product of at least alkyl acrylate with at least one reinforcing comonomer. Suitable alkyl acrylates are those having a homopolymer glass transition temperature below −10° C. and include, for example, n-butyl acrylate, 2-ethylhexylacrylate, isoctylacrylate, isononlyl acrylate, octadecyl acrylate, and the like. Suitable reinforcing monomers are those having a homopolymer glass transition temperature at or above −10° C., and include for example, acrylic acid, itaconic acid, isobornyl acrylate, N,N-dimethylacrylamide, N-vinyl caprolactam, N-vinyl pyrrolidone, and the like.

A pressure sensitive adhesive can optionally include one or more additives. Depending on the method of polymerization, the coating method, the end use, etc., additives selected from the group consisting of initiators, fillers, plasticizers, tackifiers, chain transfer agents, fibrous reinforcing agents, foaming agents, antioxidants, stabilizers, fire retardants, viscosity enhancing agents, coloring agents, and mixtures thereof can be used.

Examples of suitable release liners include any of a wide variety made of various materials. Exemplary materials include organic polymers such as polyethylene, polypropylene, polyesters, cellulose acetate, polyvinylchloride, and polyvinylidene fluoride, as well as paper or other substrates coated or laminated with such organic polymers. These embossable coated papers or thermoplastic films are often siliconized or otherwise treated to impart improved release characteristics. The thickness of the release liner can vary widely according to the desired effect. Furthermore, it is possible to afford structures to the release liner by using various techniques, such as those disclosed in U.S. Pat. No. 5,650,215 (Mazurek).

### Wipes

The present disclosure also provides a wipe (i.e., toweletter) that includes an absorbent substrate (typically, a sheet) impregnated with a cleaning and protecting composition as described herein. Such composition is impregnated at a desired weight into an absorbent substrate, which may be formed from a wide variety of woven or nonwoven fibers, fiber mixtures, and/or foams of sufficient wet strength and absorbency to hold an effective amount of the composition. It is preferred from the standpoint of cleaning and protecting effectiveness to employ absorbent substrates with a high absorbent capacity (e.g., from 5 grams/gram to 20 grams/gram, preferably from 9 grams/gram to 20 grams/gram). The absorbent capacity of an absorbent substrate is the ability of such substrate, while supported horizontally, to hold liquid. The substrates used herein are generally adhesively bonded fibers or filamentous products having a web or carded fiber structure (when the fiber strength is suitable to allow carding), or fibrous mats in which the fibers or filaments are distributed haphazardly in random array (i.e., an array of fibers in a carded web where partial orientation of the fibers is frequently present, as well as a completely haphazard distributional orientation) or substantially aligned. The fibers or filaments can be natural or synthetic.

### EMBODIMENTS

Embodiment 1 is a method of replenishing a hydrophilic surface on a writable and cleanable article, the method comprising:

providing a writable and cleanable article comprising:
a base member having a front surface;
a facing layer comprising a cured polymeric matrix and a plurality of inorganic nanoparticles dispersed in the polymeric matrix, wherein the facing layer is disposed on at least a portion of the base member front surface;
an optional primer layer disposed on at least a portion of the facing layer; and
a hydrophilic overcoat bonded to the facing layer and/or the optional primer layer through siloxane bonds, thereby providing a hydrophilic surface that is writable and cleanable;
wherein the hydrophilic overcoat has an at least partially depleted hydrophilic surface;

applying a cleaning and protecting composition to at least a portion of the hydrophilic overcoat; wherein the cleaning and protecting composition comprises:
a hydrophilic silane;
a surfactant; and
water; and

drying the cleaning and protecting composition to provide a dried surface having a replenished hydrophilic surface.

Embodiment 2 is the method of embodiment 1 wherein the base member comprises a flexible substrate.

Embodiment 3 is the method of embodiment 2 wherein the flexible substrate comprises a woven material, a nonwoven material, a knitted material, a film (e.g., a polymeric film), and the like.

Embodiment 4 is the method of embodiment 3 wherein the flexible substrate comprises a film. Embodiment 5 is the method of embodiment 3 or 4 wherein the flexible substrate comprises an organic polymer.

Embodiment 6 is the method of embodiment 5 wherein the organic polymer is selected from the group of a polyester (e.g., polyethylene terephthalate and polybutyleneterephthalate), olefin (e.g., polyethylene, polypropylene, and copolymers of propylene, ethylene, and butene), polyamide, polyimide, phenolic resin, polyvinyl chloride, polycarbonate, allyldiglycolcarbonate, polyacrylate (e.g., polymethyl methacrylate), polystyrene, styrene-acrylonitrile copolymer, polysulfone, polyethersulfone, cellulose ester (e.g., acetate and butyrate), biopolymer, polylactic acid, homo-epoxy polymer, epoxy addition polymer with a polydiamine or polydithiol, and a combination of any of the foregoing (e.g., copolymers, mixtures, or blends) thereof.

Embodiment 7 is the method of any one of embodiments 1 through 6 wherein the base member comprises an optically clear material.

Embodiment 8 is the method of embodiment 7 wherein the optically clear material is selected from the group of polyester, triacetate (TAC), polyethylene naphthalate, polycarbonate, cellulose acetate, polymethyl methacrylate, biaxially oriented polypropylene (BOPP), and simultaneously biaxially-oriented polypropylene (S-BOPP).

Embodiment 9 is the method of any one of embodiments 1 through 8 wherein the base member has a thickness of less than 0.5 mm (and typically no more than 0.2 mm).

Embodiment 10 is the method of any one of embodiments 1 through 9 wherein the base member has a thickness of at least 0.02 mm.

Embodiment 11 is the method of any one of embodiments 1 through 10 wherein the base member is chemically treated, corona treated, plasma treated, flame treated, or actinic radiation treated prior to having the facing layer disposed thereon.

Embodiment 12 is the method of any one of embodiments 1 through 11 wherein the facing layer is disposed directly on the base member front surface.

Embodiment 13 is the method of any one of embodiments 1 through 12 wherein the cured polymeric matrix comprises an organic polymeric matrix (e.g., a (meth)acrylate polymeric matrix) or an inorganic polymeric matrix (e.g., a siloxane polymeric matrix).

Embodiment 14 is the method of embodiment 13 wherein the cured polymeric matrix comprises an organic polymeric matrix.

Embodiment 15 is the method of any one of embodiments 1 through 14 wherein the cured polymeric matrix is formed from one or more monomers, oligomers, and/or polymerizable polymers, which may be monofunctional and/or polyfunctional.

Embodiment 16 is the method of embodiment 15 wherein the one or more monomers, oligomers, and/or polymerizable polymers comprise (meth)acrylates, epoxies, isocyanates, vinyl chlorides, vinyl acetates, isoprene, butadiene, styrene, trialkoxysilane-terminated oligomers and polymers, and combinations thereof.

Embodiment 17 is the method of embodiment 16 wherein the cured polymeric matrix comprises a (meth)acrylate polymer.

Embodiment 18 is the method of any one of embodiments 1 through 17 wherein the facing layer has exposed —OH groups prior to bonding to the hydrophilic overcoat.

Embodiment 19 is the method of any one of embodiments 1 through 18 wherein the inorganic nanoparticles are selected from the group of aluminum oxide, antimony tin oxide, bismuth subsalicylate, boemite, calcium carbonate, calcium phosphate, cerium dioxide, graphene, halloysite, lanthanum boride, lithium carbonate, silver, amorphous silica, colloidal silica, silicon dioxide, titanium dioxide, zinc oxide, zirconium oxide, zirconium dioxide, and combinations thereof.

Embodiment 20 is the method of any one of embodiments 1 through 19 wherein the inorganic nanoparticles comprise surface-modified inorganic nanoparticles.

Embodiment 21 is the method of embodiment 19 or 20 wherein the surface-modified inorganic nanoparticles comprise silica nanoparticles.

Embodiment 22 is the method of embodiment 21 wherein the surface-modified inorganic nanoparticles comprise a surface treated with a surface treatment agent selected from isooctyl trimethoxy-silane, N-(3-triethoxysilylpropyl) methoxyethoxyethoxyethyl carbamate (PEG3TES), SILQUEST A1230, N-(3-triethoxysilylpropyl) methoxyethoxyethoxyethyl carbamate (PEG2TES), 3-(methacryloyloxy)propyltrimethoxysilane, 3-acryloxypropyltrimethoxysilane,

3-(methacryloyloxy)propyltriethoxysilane, 3-(methacryloyloxy) propylmethyldimethoxysilane, 3-(acryloyloxypropyl)methyldimethoxysilane, 3-(methacryloyloxy)propyldimethylethoxysilane, 3-(methacryloyloxy) propyldimethylethoxysilane, vinyldimethylethoxysilane, phenyltrimethoxysilane, n-octyltrimethoxysilane, dodecyltrimethoxysilane, octadecyltrimethoxysilane, propyltrimethoxysilane, hexyltrimethoxysilane, vinylmethyldiacetoxysilane, vinylmethyldiethoxysilane, vinyltriacetoxysilane, vinyltriethoxysilane, vinyltriisopropoxysilane, vinyltrimethoxysilane, vinyltriphenoxysilane, vinyltri-t-butoxysilane, vinyltris-isobutoxysilane, vinyltriisopropenoxysilane, vinyltris(2-methoxyethoxy)silane, styrylethyltrimethoxysilane, mercaptopropyltrimethoxysilane, 3-glycidoxypropyltrimethoxysilane, acrylic acid, methacrylic acid, oleic acid, stearic acid, dodecanoic acid, 2-[2-(2-methoxyethoxy)ethoxy]acetic acid (MEEAA), beta-carboxyethylacrylate, 2-(2-methoxyethoxy)acetic acid, methoxyphenyl acetic acid, and mixtures of two or more of the foregoing.

Embodiment 23 is the method of any one of embodiments 1 through 22 wherein the cured polymeric matrix of the facing layer comprises nanoparticles in an amount of at least 15 wt-%, based on the total weight of the cured matrix and nanoparticles of the facing layer.

Embodiment 24 is the method of any one of embodiments 1 through 23 wherein the cured polymeric matrix of the facing layer comprises nanoparticles in an amount of up to 85 wt-%, based on the total weight of the cured matrix and nanoparticles of the facing layer.

Embodiment 25 is the method of any one of embodiments 1 through 24 wherein the hydrophilic overcoat comprises sulfonate-functional groups, phosphate-functional groups, phosphonate-functional groups, phosphonic acid-functional groups, carboxylate-functional groups, or a combination thereof.

Embodiment 26 is the method of embodiment 25 wherein the hydrophilic overcoat comprises sulfonate-functional groups.

Embodiment 27 is the method of any one of embodiments 1 through 26 wherein the hydrophilic overcoat comprises a zwitterionic hydrophilic overcoat.

Embodiment 28 is the method of embodiment 27 wherein the zwitterionic hydrophilic overcoat is derived from a zwitterionic compound comprising sulfonate-functional groups and alkoxysilane groups and/or silanol-functional groups.

Embodiment 29 is the method of embodiment 28 wherein the zwitterionic compound is selected from a compound having the following Formula (I) or Formula (II):

(R¹O)ₚ—Si(R²)_{q}—W—N⁺(R³)(R⁴)—(CH₂)ₘ—SO₃⁻ (I)

(R¹O)ₚ—Si(R²)_{q}—CH₂CH₂CH₂—N⁺(CH₃)₂—(CH₂)ₘ—SO₃⁻ (II)

wherein:

each R¹ is independently a hydrogen, methyl group, or ethyl group;

each R² is independently hydroxyl, (C1-C4)alkyl groups, and (C1-C4)alkoxy groups (preferably a methyl group or an ethyl group);

each R³ and R⁴ is independently a saturated or unsaturated, straight chain, branched, or cyclic organic group (preferably having 20 carbons or less), which may be joined together, optionally with atoms of the group W, to form a ring;

W is an organic linking group;

p is an integer of 1 to 3;

m is an integer of 1 to 10 (preferably, 1 to 4);

q is 0 or 1; and

p+=3.

Embodiment 30 is the method of any one of embodiments 1 through 29 wherein the hydrophilic overcoat further comprises at least one of a water soluble alkali metal silicate, a tetraalkoxysilane monomer, a tetraalkoxysilane oligomer, and an inorganic silica sol.

Embodiment 31 is the method of embodiment 30 wherein the hydrophilic overcoat further comprises a water soluble alkali metal silicate.

Embodiment 32 is the method of embodiment 31 wherein the hydrophilic overcoat comprises lithium silicate.

Embodiment 33 is the method of any one of embodiments 1 through 32 wherein the facing layer is a surface-treated facing layer.

Embodiment 34 is the method of embodiment 33 wherein the surface-treated facing layer is a plasma-treated facing layer, a corona-treated facing layer, or a flame-treated facing layer.

Embodiment 35 is the method of any one of embodiments 1 through 34 wherein the primer layer is present.

Embodiment 36 is the method of embodiment 35 wherein the primer layer comprises diamond-like glass.

Embodiment 37 is the method of any one of embodiments 1 through 36 wherein the cleaning and protecting composition comprises a weight ratio of the hydrophilic silane to the surfactant is at least 1:1.

Embodiment 38 is the method of any one of embodiments 1 through 37 wherein the cleaning and protecting composition further comprises at least one of a water soluble alkali metal silicate, a tetraalkoxysilane monomer, a tetraalkoxysilane oligomer, and an inorganic silica sol.

Embodiment 39 is the method of embodiment 38 wherein the cleaning and protecting composition comprises a water soluble alkali metal silicate.

Embodiment 40 is the method of embodiment 39 wherein the alkali metal silicate comprises at least one of lithium silicate, sodium silicate, and potassium silicate.

Embodiment 41 is the method of embodiment 40 wherein the alkali metal silicate comprises lithium silicate.

Embodiment 42 is the method of any one of embodiments 1 through 41 wherein the surfactant comprises at least one of anionic surfactant, nonionic surfactant, cationic surfactant, amphoteric betaine surfactant, amphoteric sultaine surfactant, amphoteric imidazoline surfactant, amine oxide surfactant, and quaternary cationic surfactant.

Embodiment 43 is the method of any one of embodiments 1 through 42 wherein the cleaning and protecting composition comprises at least two different surfactants.

Embodiment 44 is the method embodiment 43 wherein the cleaning and protecting composition comprises a nonionic surfactant and an anionic surfactant.

Embodiment 45 is the method of any one of embodiments 1 through 44 wherein the cleaning and protecting composition comprises at least 0.01 wt-% t of the hydrophilic silane, based on the total weight of the cleaning and protecting composition.

Embodiment 46 is the method of embodiment 45 wherein the cleaning and protecting composition comprises at least 0.1 wt-% of the hydrophilic silane, based on the total weight of the cleaning and protecting composition.

Embodiment 47 is the method of any one of embodiments 1 through 46 wherein the cleaning and protecting composition comprises no greater than 5 wt-% of the hydrophilic silane, based on the total weight of the cleaning and protecting composition.

Embodiment 48 is the method of embodiment 47 wherein the cleaning and protecting composition comprises no greater than 3 wt-% of the hydrophilic silane, based on the total weight of the cleaning and protecting composition.

Embodiment 49 is the method of embodiment 48 wherein the cleaning and protecting composition comprises no greater than 2 wt-% of the hydrophilic silane, based on the total weight of the cleaning and protecting composition.

Embodiment 50 is the method of embodiment 49 wherein the cleaning and protecting composition comprises no greater than 0.5 wt-% of the hydrophilic silane, based on the total weight of the cleaning and protecting composition.

Embodiment 51 is the method of any one of embodiments 1 through 50 wherein the hydrophilic silane has a molecular weight no greater than 1000 grams per mole.

Embodiment 52 is the method of embodiment 51 wherein the hydrophilic silane has a molecular weight no greater than 500 grams per mole.

Embodiment 53 is the method of any one of embodiments 1 through 52 wherein the hydrophilic silane is selected from the group of zwitterionic silane, hydroxyl sulfonate silane, phosphonate silane, carboxylate silane, glucanamide silane, polyhydroxyl alkyl silane, hydroxyl polyethyleneoxide silane, polyethyleneoxide silane, and combinations thereof.

Embodiment 54 is the method of embodiment 53 wherein the hydrophilic silane comprises a zwitterionic silane.

Embodiment 55 is the method of embodiment 54 wherein the zwitterionic silane comprises sulfonate-functional groups, phosphonate-functional groups, or a combination thereof. Embodiment 56 is the method of embodiment 55 wherein the zwitterionic silane comprises sulfonate-functional groups.

Embodiment 57 is the method of embodiment 56 wherein the sulfonate-functional zwitterionic silane is selected from a compound having the following Formula (I) or Formula (II):

(R¹O)ₚ—Si(R²)_{q}—W—N⁺(R³)(R⁴)—(CH₂)ₘ—SO₃⁻ (I)

(R¹O)ₚ—Si(R²)_{q}—CH₂CH₂CH₂—N⁺(CH₃)₂—(CH₂)ₘ—SO₃⁻ (II)

wherein:

each R¹ is independently a hydrogen, methyl group, or ethyl group;

each R² is independently hydroxyl, (C1-C4)alkyl groups, and (C1-C4)alkoxy groups (preferably, a methyl group or an ethyl group);

each R³ and R⁴ is independently a saturated or unsaturated, straight chain, branched, or cyclic organic group (preferably having 20 carbons or less), which may be joined together, optionally with atoms of the group W, to form a ring;

W is an organic linking group;

p is an integer of 1 to 3;

m is an integer of 1 to 10 (preferably, 1 to 4);

q is 0 or 1; and

p+q=3.

Embodiment 58 is the method of any one of embodiments 1 through 57 wherein the cleaning and protecting composition comprises two different hydrophilic silanes.

Embodiment 59 is the method of any one of embodiments 1 through 58 wherein the cleaning and protecting composition comprises no greater than 2 wt-% solids.

Embodiment 60 is the method of embodiment 59 wherein the cleaning and protecting composition comprises no greater than 1 wt-% solids.

Embodiment 61 is the method of any one of embodiments 1 through 60 wherein the hydrophilic coating on the facing layer is deposited from a composition comprising greater than 2 wt-% solids.

Embodiment 62 is the method of embodiment 61 wherein the hydrophilic coating on the facing layer is deposited from a composition comprising at least 3 wt-% solids.

Embodiment 63 is a method for cleaning and protecting a writable and cleanable article, the method comprising:

providing a writable and cleanable article comprising:
a base member having a front surface;
a facing layer comprising a cured polymeric matrix and a plurality of inorganic nanoparticles dispersed in the polymeric matrix, wherein the facing layer is disposed on at least a portion of the base member front surface;
an optional primer layer disposed on at least a portion of the facing layer; and
a hydrophilic overcoat bonded to the facing layer and/or the optional primer layer through siloxane bonds, thereby providing a hydrophilic surface that is writable and cleanable;

applying a cleaning and protecting composition to at least a portion of the writable and cleanable hydrophilic surface; wherein the cleaning and protecting composition comprises:
a hydrophilic silane;
a surfactant; and
water; and

drying the cleaning and protecting composition to provide a dried surface.

Embodiment 64 is a kit comprising:

a writable and cleanable article comprising:
a base member having a front surface;
a facing layer comprising a cured polymeric matrix and a plurality of inorganic nanoparticles dispersed in the polymeric matrix, wherein the facing layer is disposed on at least a portion of the base member front surface;
an optional primer layer disposed on at least a portion of the facing layer; and
a hydrophilic overcoat bonded to the facing layer and/or the optional primer layer through siloxane bonds, thereby providing a hydrophilic surface that is writable and cleanable; and

a cleaning and protecting composition comprising:
a hydrophilic silane;
a surfactant; and
water.

Embodiment 65 is the kit of embodiment 64 wherein the writable and cleanable article further comprise an adhesive layer on the base member back surface, and a removable liner disposed on the adhesive layer.

Embodiment 66 is the kit of embodiment 64 or 65 wherein the cleaning and protecting composition is impregnated into an absorbent substrate.

### EXAMPLES

Objects and advantages of the disclosure are further illustrated by the examples provided herein. The particular materials and amounts thereof recited in these examples, as well as other conditions and details, are merely illustrative and are not intended to be limiting. The person of ordinary skill in the art, after carefully reviewing the entirety of this disclosure, will be able to use materials and conditions in addition to those specifically described in the examples. All parts, percentages, ratios, etc. in the examples and the rest of the specification are by weight, unless noted otherwise. The terms w-t %, and % by weight are used interchangeably.

TABLE 1
Materials and sources.

| Abbreviation | Description |
|---|---|
| A174 | Silica nano-particals available from NALCO Chemical Company, Naperville, IL |
| | as 2329, modified as described below. |
| | The 75 nm silica was surface modified with 3- |
| | methacryloyloxypropyltrimethoxysilane (MPS) in the following way. 1- |
| | methoxy-2-propanol (450 grams), MPS (6.04 grams) and radical inhibitor |
| | solution (0.2 gram of a 5% solution in DI water) were mixed with a dispersion |
| | of spherical silica nano-particles (400 grams with a silica content of 40.52%) |
| | while stirring. The solution was sealed and heated to 80° C. and held at |
| | temperature for 16 hours in a 1 L glass jar. The surface modified colloidal |
| | dispersion was further processed to remove water and increase the silica |
| | concentration. A 500 ml RB flask was charged with the surface modified |
| | dispersion (450 g). Water and 1-methoxy-2-propanol were removed via rotary |
| | evaporation to give a weight of 202.85 g. 1-methoxy-2-propanol (183 g) was |
| | charged to the flask and water and 1-methoxy-2-propanol were removed via |
| | rotary evaporation to give a final weight of 188.6 g. The solution was filtered |
| | with 1 micron filter. The resulting solids content was 51.1 wt-%. |
| M1 | Monomer, pentaerythritol triacrylate available from Satomer Americas, Exton, |
| | PA as SR444 |
| PH1 | Photoinitiator, available from BASF Corp., Wyandotte, MI as IRGACURE 184 |
| S1 | Ethyl Acetate available from Sigma Aldrich, St. Louis, MO |
| W1 | Wipe, paper tissue, available from Kimberly Clark Corp., Roswell, GA as |
| | KIMWIPES |
| C1 | Cleaning pad available from 3M Company, St. Paul, MN as SCOTCH-BRITE |
| | 98 |
| T1 | Double sided tape available from 3M Company, St. Paul, MN as PSA transfer |
| | tape adhesive 9445 |
| Mark 1 | Black marker containing a combination of solvents including butanol, propanol, |
| | diacetone alcohol, ethanol, proprietary pigments, dyes and other additives, |
| | available from Rubbermaid Newell, Atlanta GA, as Black SHARPIE Pro King |
| | Size Permanent Marker |
| Mark 2 | Red marker containing N-Propanol solvent @ maximum 87% weight of |
| | composition, proprietary red dyes, available Avery Dennison, Glendale, CA as |
| | Red AVERY MARKS-A-LOT Large Desk-Style Permanent, Chisel Tip, Red |
| | 08887 |
| W2 | Wipe, towel available from Kimberly Clark Corp., Roswell, GA as WYPALL |
| | L30 |
| PET Film | Double primed 2 mil (50.8 um) thick PET film available from DuPont Teijin |
| | Films, Chester, VA as Melinex 617 film |

### Test Methods

### Film Soiling

The following procedure was used to apply marks for testing.
1. The desired marker was selected for removal (Mark 1 or Mark 2) and immobilize on the arm of a linear Taber abrader (obtained from Taber Industries, North Tonawanda, N.Y.).
2. The marker rested on the substrate with 600 g of force (250 g weight plus 350 g loading of arm).
3. A single direction stroke of the marker was applied while under load. The marker was not allowed to retrace its path and overcoat the line.
4. The mark was dried for 15 minutes at room temperature.

### Cleaning

Removability of the marks.
1. Seven hundred fifty grams (750 g) of weight was applied to the linear Taber abrader arm.
2. The marked film sample was immobilized on a flat piece of glass so that the linear Taber abrader arm would contact the film near the mark, but not touch the mark.
3. A trifolded towel (W2) was attached to the head of the linear Taber abrader with a double wrapped rubber band. It was applied to ensure a secure fit that provided an evenly covered surface with no metal of the Taber head attachment contacting the surface.
4. One milliliter (1 mL) of deionized water was applied to approximately 1-inch (2.54 cm) length of the marker line evenly on both sides and allow to sit for 10 seconds.
5. The head of the linear abrader was lowered to contact the film surface near the mark.
6. The linear Taber abrader was cycled across the mark and the number of individual cycles to completely remove the entire width of the marker line in the area being cleaned was recorded.

### Example Preparation

### Comparative Example 1, CE1

CE1 was the PET Film from Table 1. CE1 was tested using Film Soiling and Cleaning Test Methods. Results are reported for 1 test in Table 3.

### Comparative Example 2, CE2 Hydrophilic Overcoated Film

The Hydrophilic Overcoated Film was made by coating a Facing Layer Coated Film with Hydrophilic coating solution.

The Facing Layer Coated Film was made by coating the formulation of Table 2 on to PET Film from Table 1.

TABLE 2
Facing Layer Coating Solution Formulation

| Components (from Table 1) | % |
|---|---|
| Modified Silica (A174) | 43.22 |
| Sartomer SR444 (M1) | 19.05 |
| Irgacure 184 (PH1) | 0.79 |
| Ethyl Acetate (S1) | 36.94 |

The Facing Layer Coating Solution was applied at a flow rate of 5 cc/minute through a 4-inch (10.2-cm) coat hanger die. The coated film then passed through a drying zone of 10 feet (3.0 m) at 180° F. (82° C.) at a line speed of 10 ft/min (3.0 m/min). Afterwards the dried coating was cured in a Fusion UV chamber (Fusion System, Gaithersburg Md., Model #1300P) with a H 300 W-bulb. The UV chamber was purged by a nitrogen gas stream.

The Hydrophilic Overcoated Film was made by coating a Facing Layer Coated Film with Hydrophilic coating solution (4% solids solution of 2:1 ratio zwitterionic sulfonate silane:lithium silicate, Preparative Example 14 from U.S. Pat. Pub. No. 2012/0273000 A1 (Jing et al.)). The Facing Layer Coated Film went through an air corona treater at a power density of 1.7 J/cm2 to oxidize the coating surface. The oxidization not only increased the surface energy to enable the wetting of the water-based top coat solution but also generated bonding sites for zwitterion silane to adhere to. Then the corona treated roll was coated with the Hydrophilic coating solution on the treated side at the flow rate of 2 cc/min through a 4 inch (10.2 cm) coat hanger die. The coated film was passed through a drying zone of 10 feet (3.0 m) at 200° F. (93° C.) at a line speed of 10 ft/min. (3.0 m/min.). CE2 was tested using Film Soiling and Cleaning Test Methods. Results for 3 test replicates are reported in Table 3.

### Example 1, E1 Hydrophilic Overcoated Film with Additional Aqueous Coating (Using a Cleaning and Protecting Composition)

The Cleaning and Protecting Composition of Example 3 (U.S. Pat. Pub. No. 2014/0060583 (Riddle et al.)) was prepared by combining Hydrophilic Silane Solution 1 (U.S. Pat. Pub. No. 2014/0060583) (Riddle et al.)) and LSS-75 (Lithium silicate solution (Nissan Chemical Company (Houston, Tex.)) in a 50:50 weight to weight (w/w) ratio and then diluting the composition to a 0.1% by weight solution with the solution of Comparative Composition 1 (U.S. Pat. Pub. No. 2014/0060583 (Riddle et al.)).

Comparative Composition 1 (U.S. Pat. Pub. No. 2014/0060583 (Riddle et al.)) was prepared by combining, with mixing, 74.39% by weight deionized water (DT) water, 4% by weight STEPANOL WA-EXTRA PCK sodium lauryl sulfate (Stepan, Northfield, Ill.), 5% by weight isopropanol, 15% by weight GLUCOPON 425N decyl glucoside surfactant (BASF Corporation, Germany), 1% by weight potassium carbonate. 0.5% by weight chemically pure glycerin, 0.1% by weight apple fragrance, and 0.01% by weight FD&C dye No. 1. The solution was then diluted with water to a ratio of 1:60.

Hydrophilic Silane Solution 1 (U.S. Pat. Pub. No. 2014/0060583) (Riddle et al.)) was prepared by combining 49.7 g of a 239 mmol solution of 3-(N,N-dimethylaminopropyl)trimethoxysilane (Sigma Aldrich), 82.2 g of deionized (DI) water, and 32.6 g of a 239 mmol solution of 1,4-butane sultone (Sigma Aldrich) in a screw-top jar. The mixture was heated to 75° C., mixed, and allowed to react for 14 hours.

Aqueous Coating (Example 3 U.S. Pat. Pub. No. 2014/0060583 (Riddle et al.)) was applied onto the coated surface of the Hydrophilic Overcoated Film, 1 mL on a 4-inch (10.2-cm)×3-inch (7.6-cm) sample of film. The Aqueous Coating was wiped evenly 10 times with a wipe (W1) across the surface and allow to dry at least 30 minutes (completely evaporated surface moisture). E1 was tested using Film Soiling and Cleaning Test Methods. Results for 3 test replicates are reported in Table 3.

### Comparative Example 3, CE3 Abraded Hydrophilic Overcoated Film

The Abraded Hydrophilic Overcoated Film was prepared by abrading the coated side of CE2. One-inch (1-inch) (2.54-cm) by 1-inch (2.54-cm) pieces of (C1) pads were cut and attached to the head of the linear Taber abrader using tape (T1). Seven hundred fifty grams (750 g) of weight was added to the linear Taber abrader arm. CE2 film was secured to a piece of glass with T1 and place under the linear Taber abrader. The head of linear Taber abrader was lowered to the surface of CE2 film and cycled at 75 cycles/min with a 2-inch (5.1-cm) scour path. After 200 cycles had been performed the abrader was stopped. CE3 was tested using Film Soiling and Cleaning Test Methods. Results for 4 test replicates are reported in Table 3.

### Example 2, E2 Abraded Hydrophilic Overcoated Film with Additional Aqueous Coating (Formed from a Cleaning and Protecting Composition)

The Abraded Hydrophilic Film with Additional Aqueous Coating was prepared by applying Aqueous Coating (Example 3 U.S. Pat. Pub. No. 2014/0060583 (Riddle et al.)) to the abraded coated surface of CE3—Abraded Hydrophilic Overcoated Film, 1 mL on a 4-inch (10.2-cm)×3-inch (7.6-cm). The Aqueous Coating was wiped evenly 10 times with a wipe (W1) across the surface and allow to dry at least 30 minutes (completely evaporated surface moisture). E2 was tested using Film Soiling and Cleaning Test Methods. Results for 4 test replicates are reported in Table 3.

TABLE 3
Results

| | Cycles to Clean | |
|---|---|---|
| Example | Black Mark 1 | Red Mark 2 |
| CE1 | >50 (test stopped, | >50 (test stopped, |
| | not clean) | not clean) |
| CE2 | 3 | 9 |
| CE2 | 6 | 11 |
| CE2 | 6 | 13 |
| E1 | 1 | 5 |
| E1 | 1 | 5 |
| E1 | 1 | 5 |
| CE3 | 9 | 18 |
| CE3 | 10 | 25 |
| CE3 | 8 | 27 |
| CE3 | 13 | 20 |
| E2 | 2 | 11 |
| E2 | 4 | 8 |
| E2 | 3 | 10 |
| E2 | 3 | 13 |

CE2 is an example of a writable and cleanable article of the present disclosure having a hydrophilic overcoat. CE3 is an example of a writable and cleanable article wherein the hydrophilic overcoat has an at least partially depleted hydrophilic surface. This depletion would result from use over time, as demonstrated by the abrasion test. E1 demonstrates improvement (1 vs. 3-6 cycles for Black Mark 1 and 5 vs. 9-13 cycles for Red Mark 2) in the cleanability of an unused writable and cleanable article of CE2 upon application of a cleaning and protecting composition of the present disclosure. E2 demonstrates improvement (2-4 vs. 8-13 cycles for Black Mark 1 and 8-13 vs. 18-27 cycles for Red Mark 2) in the cleanability of a used (i.e., “abraded”) writable and cleanable article of CE2 (i.e., CE3) upon application of a cleaning and protecting composition of the present disclosure. These results also demonstrate that the cleaning and protecting composition can replenish performance, particularly with respect to cleanability, to that of (or close to that of) an original, unused writable and cleanable article. Compare the results of E2 to that of CE2 (2-4 vs. 3-6 cycles for Black Mark 1 and 8-13 vs. 9-13 for Red Mark 2).

The complete disclosures of the patents, patent documents, and publications cited herein are incorporated by reference in their entirety as if each were individually incorporated. Various modifications and alterations to this invention will become apparent to those of ordinary skill in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

1. A method of replenishing a hydrophilic surface on a writable and cleanable article, the method comprising:
providing a writable and cleanable article comprising:
a base member having a front surface;
a facing layer comprising a cured polymeric matrix and a plurality of inorganic nanoparticles dispersed in the polymeric matrix, wherein the facing layer is disposed on at least a portion of the base member front surface;
an optional primer layer disposed on at least a portion of the facing layer; and
a hydrophilic overcoat bonded to the facing layer and/or the optional primer layer through siloxane bonds, thereby providing a hydrophilic surface that is writable and cleanable;
wherein the hydrophilic overcoat has an at least partially depleted hydrophilic surface;
applying a cleaning and protecting composition to at least a portion of the hydrophilic overcoat; wherein the cleaning and protecting composition comprises:
a hydrophilic silane;
a surfactant; and
water; and
drying the cleaning and protecting composition to provide a dried surface having a replenished hydrophilic surface.

2. The method of claim 1 wherein the base member comprises a flexible substrate.

3. The method of claim 2 wherein the flexible substrate comprises a film.

4. The method of claim 1 wherein the cured polymeric matrix comprises an organic polymeric matrix.

5. The method of claim 4 wherein the cured polymeric matrix comprises a (meth)acrylate polymer.

6. The method of claim 1 the inorganic nanoparticles are selected from the group of aluminum oxide, antimony tin oxide, bismuth subsalicylate, boemite, calcium carbonate, calcium phosphate, cerium dioxide, graphene, halloysite, lanthanum boride, lithium carbonate, silver, amorphous silica, colloidal silica, silicon dioxide, titanium dioxide, zinc oxide, zirconium oxide, zirconium dioxide, and combinations thereof.

7. The method of claim 1 wherein the hydrophilic overcoat comprises sulfonate-functional groups, phosphate-functional groups, phosphonate-functional groups, phosphonic acid-functional groups, carboxylate-functional groups, or a combination thereof.

8. The method of claim 1 wherein the hydrophilic overcoat is formed from a zwitterionic compound having the following Formula (I) or Formula (II):
(R¹O)ₚ—Si(R²)_{q}—W—N⁺(R³)(R⁴)—(CH₂)ₘ—SO₃⁻ (I)
(R¹O)ₚ—Si(R²)_{q}—CH₂CH₂CH₂—N⁺(CH₃)₂—(CH₂)ₘ—SO₃⁻ (II)
wherein:
each R¹ is independently a hydrogen, methyl group, or ethyl group;
each R² is independently hydroxyl, (C1-C4)alkyl groups, and (C1-C4)alkoxy groups (preferably a methyl group or an ethyl group);
each R³ and R⁴ is independently a saturated or unsaturated, straight chain, branched, or cyclic organic group (preferably having 20 carbons or less), which may be joined together, optionally with atoms of the group W, to form a ring;
W is an organic linking group;
p is an integer of 1 to 3;
m is an integer of 1 to 10 (preferably, 1 to 4);
q is 0 or 1; and
p+q=3.

9. The method of claim 1 wherein the cleaning and protecting composition comprises a weight ratio of the hydrophilic silane to the surfactant is at least 1:1.

10. The method of claim 1 wherein the cleaning and protecting composition further comprises at least one of a water soluble alkali metal silicate, a tetraalkoxysilane monomer, a tetraalkoxysilane oligomer, and an inorganic silica sol.

11. The method of claim 1 wherein the cleaning and protecting composition comprises at least two different surfactants.

12. The method of claim 1 wherein the hydrophilic silane is a sulfonate-functional zwitterionic silane having the following Formula (I) or Formula (II):
(R¹O)ₚ—Si(R²)_{q}—W—N⁺(R³)(R⁴)—(CH₂)ₘ—SO₃⁻ (I)
(R¹O)ₚ—Si(R²)_{q}—CH₂CH₂CH₂—N⁺(CH₃)₂—(CH₂)ₘ—SO₃⁻ (II)
wherein:
each R¹ is independently a hydrogen, methyl group, or ethyl group;
each R² is independently hydroxyl, (C1-C4)alkyl groups, and (C1-C4)alkoxy groups (preferably, a methyl group or an ethyl group);
each R³ and R⁴ is independently a saturated or unsaturated, straight chain, branched, or cyclic organic group (preferably having 20 carbons or less), which may be joined together, optionally with atoms of the group W, to form a ring;
W is an organic linking group;
p is an integer of 1 to 3;
m is an integer of 1 to 10 (preferably, 1 to 4);
q is 0 or 1; and
p+q=3.

13. The method of claim 1 wherein the cleaning and protecting composition comprises two different hydrophilic silanes.

14. A method for cleaning and protecting a writable and cleanable article, the method comprising:
providing a writable and cleanable article comprising:
a base member having a front surface;
a facing layer comprising a cured polymeric matrix and a plurality of inorganic nanoparticles dispersed in the polymeric matrix, wherein the facing layer is disposed on at least a portion of the base member front surface;
an optional primer layer disposed on at least a portion of the facing layer; and
a hydrophilic overcoat bonded to the facing layer and/or the optional primer layer through siloxane bonds, thereby providing a hydrophilic surface that is writable and cleanable;
applying a cleaning and protecting composition to at least a portion of the writable and cleanable hydrophilic surface; wherein the cleaning and protecting composition comprises:
a hydrophilic silane;
a surfactant; and
water; and
drying the cleaning and protecting composition to provide a dried surface.

15. A kit comprising:
a writable and cleanable article comprising:
a base member having a front surface;
a facing layer comprising a cured polymeric matrix and a plurality of inorganic nanoparticles dispersed in the polymeric matrix, wherein the facing layer is disposed on at least a portion of the base member front surface;
an optional primer layer disposed on at least a portion of the facing layer; and
a hydrophilic overcoat bonded to the facing layer and/or the optional primer layer through siloxane bonds, thereby providing a hydrophilic surface that is writable and cleanable; and
a cleaning and protecting composition comprising:
a hydrophilic silane;
a surfactant; and
water.
